(19) United States
(12) Patent Application Publication
(10) Pub. No.: US 2026/0032690 A1
(43) Pub. Date: Jan. 29, 2026

(54) A METHOD FOR INFORMATION TRANSMISSION AND RECEPTION [BACKHAUL LINK BEAM INDICATION]

(71) Applicant: Samsung Electronics Co., Ltd., Gyeonggi-do (KR)

(72) Inventors: Zhe CHEN, Beijing (CN); Feifei SUN, Beijing (CN); Bin YU, Beijing (CN); Jingxing FU, Beijing (CN)

(21) Appl. No.: 18/994,398

(22) PCT Filed: Jul. 13, 2023
(86) PCT No.: PCT/KR2023/010000

§ 371 Date: Jan. 14, 2025

(30) Foreign Application Priority Data
Jul. 15, 2022 (CN) 202210837836.1
Sep. 30, 2022 (CN) 202211216067.X
Oct. 26, 2022 (CN) 202211327318.1

(51) Int. Cl. H04W 72/23; H04L 5/00

(52) U.S. Cl. CPC H04W 72/23; H04L 5/0026

(57) ABSTRACT

The disclosure relates to a 5G or 6G communication system for supporting a higher data transmission rate. In one embodiment. a method performed by a repeater is provided. The repeater is comprised a first unit and a second unit. The method comprising the step of obtaining beam-related information of the first unit, and performing at least one of downlink reception or uplink transmission through the second unit based on the beam-related information of the first unit. In another embodiment. a repeater is provided. the repeater comprises a transceiver and a controller. The controller is configured to obtain beam-related information of a first unit of the repeater, and perform at least one of downlink reception or uplink transmission through a second unit of the repeater based on the beam-related information.

### TECHNICAL FIELD

The present application relates to the technical field of wireless communication, and more particularly, to a method and device for receiving and transmitting information. Background Art

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Transmission from a base station to a user equipment (UE) is called downlink, and transmission from a UE to a base station is called uplink.

### DISCLOSURE OF INVENTION

### Technical Problem

The present disclosure relates to wireless communication systems and, more specifically, this disclosure relates to a method for information transmission and reception [Backhaul link beam indication].

### Solution to Problem

In one embodiment, a method performed by a repeater is provided. The repeater is comprised a first unit and a second unit. The method comprising the step of obtaining beam-related information of the first unit, and performing at least one of downlink reception or uplink transmission through the second unit based on the beam-related information of the first unit.

In another embodiment, a repeater is provided, the repeater comprises a transceiver and a controller. The controller is configured to obtain beam-related information of a first unit of the repeater, and perform at least one of downlink reception or uplink transmission through a second unit of the repeater based on the beam-related information.

### Advantageous Effects of Invention

Advantages, and salient features of the invention will become apparent to those skilled in the art from the following detailed description, which, taken in conjunction with the annexed drawings, discloses exemplary embodiments of the invention.

According to various embodiments of the present disclosure, method and apparatus for latency reduction for transmission or reception of data may be provide.

### BRIEF DESCRIPTION OF DRAWINGS

The above and other aspects, features and advantages of the present invention will become more apparent from the following detailed description when taken in conjunction with the accompanying drawings.

FIG. 1 illustrates an overall structure of an example wireless communication network according to embodiments of the disclosure;

FIGS. 2A and 2B respectively illustrate a transmission path 200 and a reception path 250 in a wireless communication network according to embodiments of the disclosure;

FIGS. 3A and 3B respectively illustrate the structures of a user equipment (UE) and a base station in a wireless communication network according to embodiments of the disclosure;

FIG. 4 illustrates an example network including an NCR according to embodiments of the disclosure;

FIG. 5 illustrates an example structure of an NCR according to embodiments of the disclosure;

FIG. 6 illustrates a method 600 performed by an NCR according to embodiments of the disclosure;

FIG. 7 illustrates another method 700 performed by an NCR according to embodiments of the disclosure;

FIG. 8 illustrates a method 800 performed by a base station according to embodiments of the disclosure;

FIG. 9 illustrates a structure 900 of a base station according to embodiments of the disclosure;

FIG. 10 illustrates another structure 1000 of a network-controlled repeater according to embodiments of the disclosure.

### MODE FOR THE INVENTION

Whereinafter, embodiments of the disclosure will be described in detail with reference to the accompanying drawings. It should be noted that in the drawings, the same or similar elements are denoted by the same or similar reference numerals as far as possible. In addition, detailed descriptions of known functions or configurations that may make the subject matter of the disclosure unclear will be omitted.

In describing the embodiments of the disclosure, descriptions related to technical contents that are well known in the field and not directly related to the disclosure will be omitted. Such unnecessary description is omitted to prevent the main idea of the disclosure from being blurred and to convey the main idea more clearly.

For the same reason, some elements may be exaggerated, omitted or schematically shown in the drawings. In addition, the size of each component does not fully reflect the actual size. In the drawings, the same or corresponding elements have the same reference numerals.

The advantages and features of the disclosure and the way to achieve them will become clear by referring to the embodiments described in detail below in conjunction with the accompanying drawings. However, the disclosure is not limited to the embodiments set forth below, but can be realized in various forms. The following examples are provided only to fully disclose the disclosure and to inform those skilled in the art of its scope, and the disclosure is turned only limited by the scope of the appended claims. Throughout this specification, the same or similar reference numerals indicate the same or similar elements.

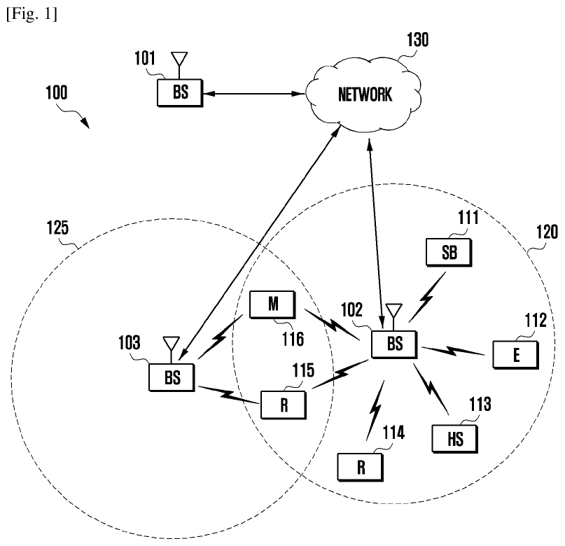

FIG. 1 illustrates an example wireless network 100 according to various embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicatewith each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

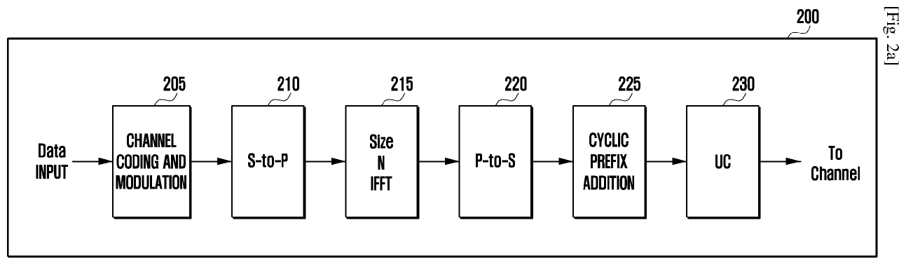

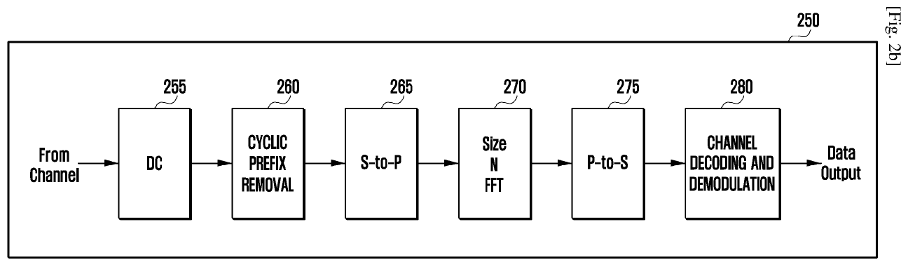

FIGS. 2a and 2b illustrate example wireless transmission and reception paths according to the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

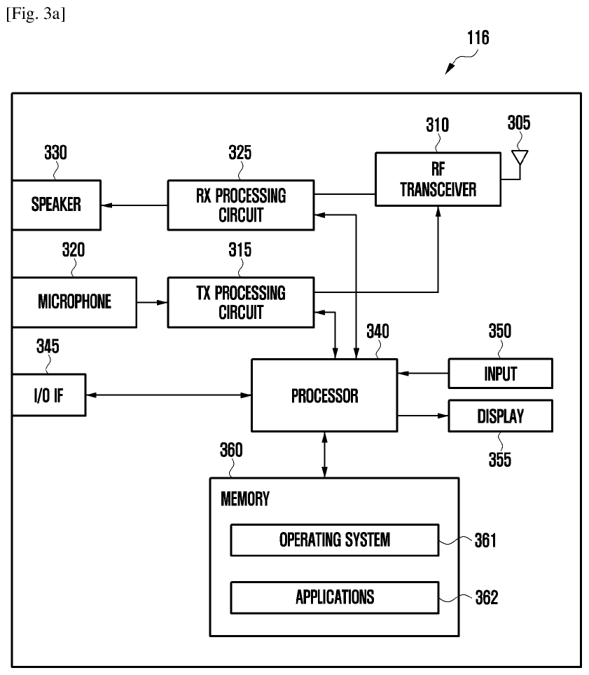

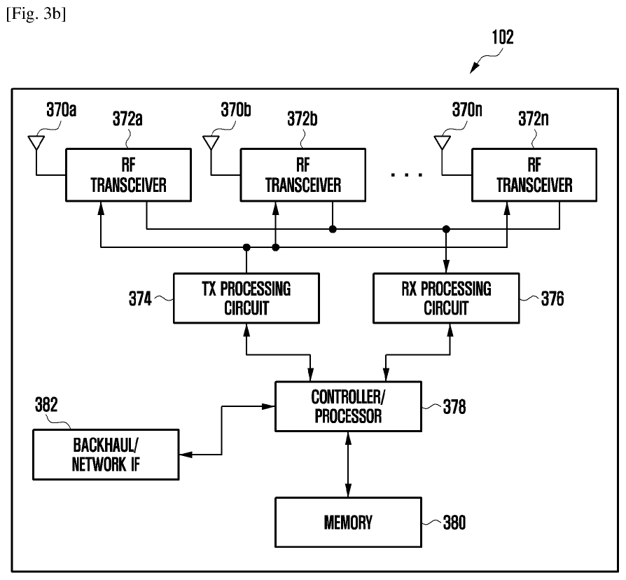

FIG. 3a illustrates an example UE 116 according to the disclosure. The embodiment of UE 116 shown in FIG. 3a is for illustration only, and UEs 111-115 of FIG. 1 can have the same or similar configuration. However, a UE has various configurations, and FIG. 3a does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the disclosure. The embodiment of gNB 102 shown in FIG. 3b is for illustration only, and other gNBs of FIG. 1 can have the same or similar configuration. However, a gNB has various configurations, and FIG. 3b does not limit the scope of the disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In order to enhance the coverage of a 5G wireless communication system, one method is to set up a repeater at the edge of a cell (or an area with poor cell signal coverage). Generally, a repeater is usually divided into two sides, a base station side and a terminal side. FIG. 4 illustrates an example network including an NCR according to embodiments of the disclosure. As shown in FIG. 4, for the downlink of a base station, the repeater receives radio frequency (RF) signals from the base station. These RF signals pass through a built-in amplifier in the repeater and the amplified signals are transmitted to the terminal device at the terminal side of the repeater. For the uplink of the base station, the repeater receives radio frequency (RF) signals from the terminal device at the terminal side. These RF signals pass through the built-in amplifier in the repeater and the amplified signals are transmitted to the terminal device at the base station side of the repeater.

Generally, the existing repeater cannot be controlled by the base station. That is, the on/off of the repeater, the timing of uplink and downlink forwarding and the direction of uplink and downlink forwarding are all achieved through techniques implemented by the repeater itself/in a way of manual setting adjustment, which is not beneficial to the flexibility of network distribution and the coverage of the repeater. In order to overcome the above shortcomings, one solution is to integrate a terminal device for the repeater, which can communicate with network devices (e.g., base stations) in order to flexibly control the repeater. Such a repeater integrated with the terminal device is called a network-controlled repeater, NCR.

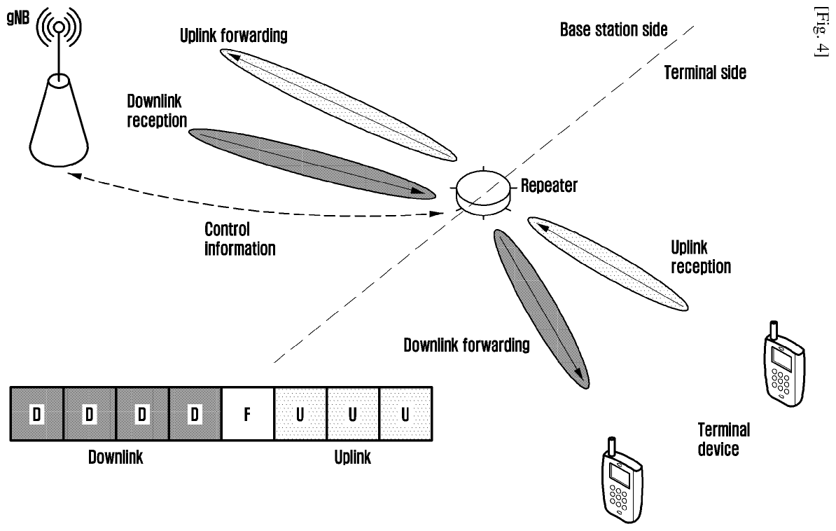

FIG. 5 illustrates an example structure of the NCR according to embodiments of the disclosure. As shown in FIG. 5, the NCR has two functional entities: a first unit and a second unit. It can be understood that in the disclosure, the repeater (NCR) and the naming thereof are only exemplary and not limiting. Particularly, in the disclosure, take the network-controlled repeater mobile terminal (NCR-MT) as an example of the first unit, and the network-controlled repeater forward (NCR-Fwd) as an example of the second unit, in which:
The NCR-MT is defined as a functional entity for information exchange (for example, side control information) with the base station. Here, the link between the NCR-MT and the base station is called a control link (C-link). In addition, the side control information is at least used to control the NCR-Fwd.
The NCR-Fwd is defined as a functional entity for amplifying and forwarding radio frequency signals (e.g., uplink/downlink radio frequency signals) between the base station and a UE. The link between the NCR-Fwd and the base station is called a backhaul link; and the link between the NCR-Fwd and the UE is called an access link.

In the disclosure, NCR can refer to NCR-MT or NCR-Fwd, or a combination of both. Optionally, the NCR-MT can also be equivalently understood as a UE, that is, it can be equivalently understood as a terminal device (UE).

In order to avoid ambiguity, corresponding names are defined here for transmission and reception behaviors of the repeater. Referring back to FIG. 4, for the NCR, or for the NCR-Fwd, radio frequency signal reception for downlink (or radio frequency signal reception at the base station side; or radio frequency signal reception on the backhaul link) is called downlink reception; radio frequency signal transmission for downlink (or radio frequency signal transmission at the terminal side; or radio frequency signal forwarding to the terminal; or radio frequency signal transmission on the access link) is called downlink forwarding; radio frequency signal reception for uplink (or radio frequency signal reception at the terminal side; or radio frequency signal reception on the access link) is called uplink reception; radio frequency signal transmission for uplink (or radio frequency signal transmission at the base station side; or radio frequency signal forwarding to the base station; or radio frequency signal transmission on the backhaul link) is called uplink forwarding.

The current NCR has the problem that there is currently no beam indication method for uplink forwarding and/or downlink reception of the NCR-Fwd, which means that the uplink forwarding and/or downlink reception beam of the NCR-Fwd cannot be adjusted in time through the base station, leading to the degradation of the link quality of the backhaul link and affecting the coverage ability of the NCR and therefore leading the performance degrade of the communication system.

In order to solve the above problems, the disclosure proposes a series of methods for indicating the beam of the NCR-Fwd. These methods enable the NCR-Fwd to use appropriate beam for downlink reception and/or the uplink forwarding, thereby improving the link quality between the NCR and the base station, improving the coverage and/or reliability of the NCR, and thereby improving the performance of the communication system. This will be described in detail below through specific embodiments and examples.

In the disclosure, the beam may be understood as at least one of the followings: a/an (uplink forwarding/downlink reception) spatial filter; quasi-co-location (QCL) assumption; QCL parameters (QCL-typeD parameters/reference signal); a transmission configuration indication (TCI) state; a Rel-17 TCI state (a unified TCI state); spatial relationship; information related to sounding reference signal (SRS) (e.g., an SRS resource indicator (SRI)). Optionally, the beam may be understood as a TCI state/reference signal/channel/spatial relationship; or a TCI state ID/reference signal ID/channel ID/spatial relationship ID; or a spatial filter associated with a TCI state/reference signal/channel/spatial relationship; or a spatial filter associated with a TCI state ID/reference signal ID/channel ID/spatial relationship ID.

### Embodiment 1 (NCR-Fwd Explicit Beam Indication)

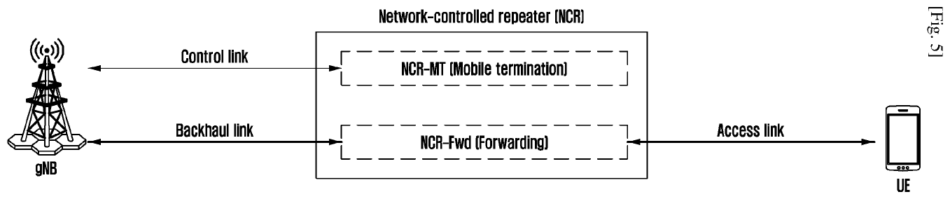

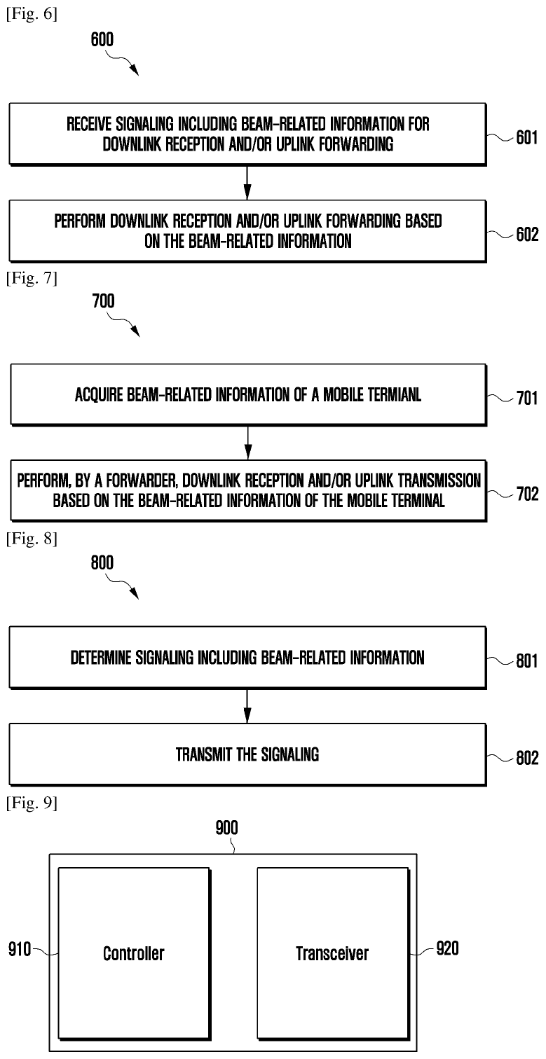

FIG. 6 illustrates a method 600 performed by an NCR according to embodiments of the disclosure. The method 600 includes, at 601, receiving, from a base station, signaling including beam-related information for downlink reception and/or uplink forwarding; at 602, performing downlink reception and/or uplink forwarding based on the beam-related information.

The NCR receives indication signaling indicating (one or more) beam information from the base station; here, the NCR may be understood as the NCR-MT, and the NCR-MT is used as an example in the following description.

The NCR determines a beam corresponding to the NCR-Fwd of the NCR according to the (one or more) beam information indicated by the indication signaling. It can be understood here that the NCR determines/adjusts the corresponding beam of the NCR-Fwd according to the indication signaling received by the NCR-MT. In the following examples, take a spatial filter associated with a TCI state/reference signal/channel as an example of the beam.

The above indication signaling may be configuration signaling (for example, radio resource control (RRC)), medium access control resource element (MAC-CE) or downlink control information (DCI). Further description is given below through specific examples.

### Example 1 (RRC)

In this example, the indication signaling is the configuration signaling, and RRC is taken as an example. Optionally, the configuration signaling may correspond to one beam information, or may correspond to multiple beam information. Optionally, the one or more beam information configured by the RRC signaling is a subset of a beam information list. Optionally, the beam information list may be understood as tci-StatesToAddModList and/or tci-StatesToReleaseList. Optionally, the beam information list may be understood as dl-OrJoint-TCIStateList or dl-OrJoint-TCI-State-ToAddModList.

Optionally, the tci-StatesToAddModList and/or tci-StatesToReleaseList are in PDSCH-Config. Optionally, the PDSCH-Config is in an active BWP of a cell/serving cell (the cell/serving cell is, for example, the PCell of the NCR-MT; the cell, for example, is indicated by the base station, or the ID of the cell is indicated by the base station; the cell, for example, is the cell that the beam indication signaling (e.g., RRC)) is received.

Optionally, the dl-OrJoint-TCI-State-ToAddModList or dl-OrJoint-TCIStateList is in PDSCH-Config. Optionally, the PDSCH-Config is in an active BWP of a cell/serving cell (the cell/serving cell is, for example, the PCell of the NCR-MT; the cell, for example, is indicated by the base station, or the ID of the cell is indicated by the base station; the cell, for example, is the cell that the beam indication signaling (e.g., RRC)) is received.

When the indication signaling corresponds to one beam information, the beam is determined by the one beam information.

Optionally, the beam information refers to at least one of the followings: a TCI state information ID (for example, TCI-StateId, UL-TCIState-Id); a control resource set (CORESET) ID; a reference signal ID (for example, an SSB ID, a CSI-RS ID, an SRS ID/SRI); a spatial relationship ID. Optionally, the beam information may be related to the NCR-MT. Optionally, the beam information refers to the beam information (configured for the NCR-MT) corresponding to the NCR-MT. For example, the TCI state information ID refers to an index of the (configured) TCI state information associated to the NCR-MT.

Optionally, the beam information is a TCI state ID.

Optionally, the beam information is a UL TCI state ID.

Optionally, the beam information is a CORESET ID.

Optionally, the beam information is a reference signal ID.

Optionally, the beam information is a reference signal type.

Optionally, the beam information is a spatial relationship ID.

Optionally, the beam information is an SRI.

Optionally, the beam information is associated with a cell and/or a BWP.

When the NCR-MT receives higher-layer configuration corresponding to one (single) beam information (higher-layer configuration of (single) beam information), the NCR (NCR-MT) performs at least one of the following methods:
Method #1. The NCR determines that the spatial filter for downlink reception used by the NCR-Fwd is the same as the one associated with the beam information; optionally, the NCR-Fwd of the NCR applies (uses) the spatial filter associated with the beam information for downlink reception;
Method #2. The NCR determines that the spatial filter for uplink forwarding used by the NCR-Fwd is the same as the one associated with the beam information; optionally, the NCR-Fwd of the NCR applies (uses) the spatial filter associated with the beam information for uplink forwarding.

Optionally, the NCR determines to use Method #1 and/or Method #2 at least according to the indication information from the base station.

Optionally, the NCR determines to use Method #1 and/or Method #2 at least according to beam correspondence capability of the NCR-MT.

Optionally, the NCR determines to use Method #1 and/or Method #2 at least according to whether the NCR-MT is configured with a unified TCI state.

Optionally, the above beam information may correspond to at least one of the followings:
the lowest ID, a (serving) cell with the lowest ID in a frequency band, a PCell/PSCell/SpCell, a cell whose ID is indicated by the base station (the signaling). Optionally, the frequency band refers to the frequency band corresponding to the NCR-Fwd. For another example, the cell refers to the cell that the beam information is received. For another example, if no cell ID is indicated/configured, the cell refers to the cell that the beam information is received. For another example, if the base station indicates the cell ID corresponding to the beam information, the cell is the cell corresponding to the cell ID; if the base station does not indicate/configure the cell information (for example, cell ID) corresponding to the beam information, then the cell refers to the cell that the beam information is received.
a BWP. For example, an active BWP, a BWP with the lowest ID, an initial BWP, or a BWP with the ID indicated by the base station (the signaling). Optionally, the BWP refers to an uplink BWP and/or a downlink BWP.
a TCI state ID. For example, a TCI-StateId.
Optionally, the TCI state ID corresponds to a TCI state of a PDSCH.
Optionally, the TCI state ID corresponds to a TCI state of a PDCCH/CORESET.
Optionally, the TCI state ID corresponds to a joint TCI state.
Optionally, when the TCI state ID corresponds to the joint TCI state (in other words, when a cell corresponding to the TCI state ID is configured with the joint TCI state, that is, unifiedTCItci-StateType=‘joint’), the NCR performs Method #1 and Method #2.
Optionally, the TCI state ID corresponds to a DL TCI state.
Optionally, when the TCI state ID corresponds to a DL TCI state (in other words, when a cell corresponding to the TCI state ID is configured with the DL TCI state and an UL TCI state, that is, unifiedTCItci-StateType=‘separate’), the NCR performs Method #1.
Optionally, the TCI state ID does not correspond to a unified/Rel-17 TCI state.
Optionally, when the TCI state ID does not correspond to the unified/Rel-17 TCI state (in other words, when a cell corresponding to the TCI state ID is not configured with a unified TCI state type, for example, unifiedTCItci-StateType), the NCR performs Method #1.
Optionally, when the TCI state ID does not correspond to the unified/Rel-17 TCI state (in other words, when a cell corresponding to the TCI state ID is not configured with the unified TCI state type, for example, unifiedTCItci-StateType), and when the NCR-MT of the NCR does not support the beam correspondence capability (in other words, the NCR indicates that the beamCorrespondenceWithoutUL-BeamSweeping is set to ‘0’), the NCR performs Method #1.
Optionally, when the TCI state ID does not correspond to the unified/Rel-17 TCI state (in other words, when a cell corresponding to the TCI state ID is not configured with the unified TCI state type, for example, unifiedTCItci-StateType), the NCR performs Method #1 and Method #2.
Optionally, when the TCI state ID does not correspond to the unified/Rel-17 TCI state (in other words, when a cell corresponding to the TCI state ID is not configured with the unified TCI state type, for example, unifiedTCItci-StateType), and when the NCR-MT of the NCR supports the beam correspondence capability (in other words, the NCR indicates that beamCorrespondenceWithoutUL-BeamSweeping is set to ‘1’, the beamCorrespondenceWithoutUL-BeamSweeping indicates how UE supports FR2 beam correspondence), the NCR performs Method #1 and Method #2.
an uplink TCI state ID. For example, a TCI-UL-State-Id.
Optionally, the NCR performs Method #2.
Optionally, when a cell corresponding to the TCI state ID is configured with a DL TCI state and an UL TCI state (that is, unifiedTCItci-StateType=‘separate’), the NCR performs Method #2.
a reference signal ID. Optionally, the reference signal refers to at least one of an SSB, a CSI-RS, and an SRS. Optionally, the reference signal ID refers to a reference signal resource ID. Optionally, if the reference signal refers to the SSB, then the ID refers to an SSB ID and an STC ID (an SSB timing configuration index). Optionally, the reference signal ID corresponds to a capability (group) ID. Optionally, the reference signal ID corresponds to a panel ID.
Optionally, the NCR performs Method #1 and Method #2.
Optionally, when the NCR-MT of the NCR supports the beam correspondence capability (in other words, the NCR indicates that the beamCorrespondenceWithoutUL-Beam-Sweeping is set to ‘1’), the NCR performs Method #1 and Method #2.
Optionally, when the reference signal ID corresponds to a downlink reference signal (for example, an SSB or a CSI-RS), the NCR performs Method #1.
Optionally, when the reference signal ID corresponds to a downlink reference signal (for example, an SSB or a CSI-RS), and the NCR-MT of the NCR does not support the beam correspondence capability (in other words, the NCR indicates that the beamCorrespondenceWithoutUL-BeamSweeping is set to ‘0’), the NCR performs Method #1.
Optionally, when the reference signal ID corresponds to an uplink reference signal (for example, an SRS), the NCR performs Method #2.
Optionally, when the reference signal ID corresponds to an uplink reference signal (for example, an SRS), and the NCR-MT of the NCR does not support the beam correspondence capability (in other words, the NCR indicates that the beamCorrespondenceWithoutUL-BeamSweeping is set to ‘0’), the NCR performs Method #2.
a reference signal type. For example, the reference signal type may be one of an SSB, a CSI-RS, and an SRS. Optionally, the reference signal type may be one of the SSB and the CSI-RS.
a CORESET ID. Optionally, the CORESET ID refers to the a QCL assumption/TCI state corresponding to a CORESET corresponding to the CORESET ID. When the ID is 0, it corresponds to CORESET #0.
Optionally, the NCR performs Method #1 and Method #2.
Optionally, when the NCR-MT of the NCR supports the beam correspondence capability (in other words, the NCR indicates that the beamCorrespondenceWithoutUL-Beam-Sweeping is set to ‘1’), the NCR performs Method #1 and Method #2.
Optionally, the NCR performs Method #1.
Optionally, the NCR-MT does not support the beam correspondence capability (in other words, when the NCR indicates that beamCorrespondenceWithoutUL-Beam-Sweeping is set to ‘0’), the NCR performs Method #1.
Optionally, a cell corresponding to the CORESET ID is not configured with a unified TCI state (that is, the unifiedTCItci-StateType is not configured).
an SRS-related ID (e.g., an SRI, an SRS Resource ID, an SRS Resource Group ID).
Optionally, the NCR performs Method #1 and Method #2.
Optionally, when the NCR-MT of the NCR supports the beam correspondence capability (in other words, the NCR indicates that the beamCorrespondenceWithoutUL-Beam-Sweeping is set to ‘1’), the NCR performs Method #1 and Method #2.
Optionally, the NCR performs Method #2.
Optionally, when the NCR-MT of the NCR does not support the beam correspondence capability (in other words, the NCR indicates that the beamCorrespondenceWithoutUL-BeamSweeping is set to ‘0’), the NCR performs Method #2.
a Spatial relationship ID. For example, a PUCCH spatial relationship ID (PUCCH-SpatialRelationInfold), an SRS spatial relationship ID.
Optionally, the NCR performs Method #1 and Method #2.
Optionally, when the NCR-MT of the NCR supports the beam correspondence capability (in other words, the NCR indicates that the beamCorrespondenceWithoutUL-Beam-Sweeping is set to ‘1’), the NCR performs Method #1 and Method #2.
Optionally, the NCR performs Method #2.
Optionally, when the NCR-MT of the NCR does not support the beam correspondence capability (in other words, the NCR indicates that the beamCorrespondenceWithoutUL-BeamSweeping is set to ‘0’), the NCR performs Method #2.

In the method, when the NCR-MT supports beam correspondence and when the NCR-MT does not support the beam correspondence, behaviors of the NCR-Fwd may be different. This is because when the NCR-MT supports the beam correspondence, the NCR-Fwd also supports the beam correspondence. Therefore, one beam information can be used to simultaneously indicate the spatial filter used by the NCR-Fwd for downlink reception and uplink forwarding. When the NCR-MT does not support the beam correspondence, the NCR-Fwd also does not support the beam correspondence. Therefore, one beam information can only indicate the spatial filter used by the NCR-Fwd for downlink reception or uplink forwarding.

In addition, for the disclosure, one way of understanding the spatial filter associated with the TCI state ID is: a spatial filter associated with a QCL-typeD reference signal corresponding to the TCI state.

In addition, for the disclosure, one way of understanding the spatial filter associated with the uplink TCI state ID is: a spatial filter associated with a reference signal (e.g., an SRS) corresponding to the uplink TCI state ID.

### Example 2 (MAC CE)

In this example, the indication signaling is MAC-CE or DCI, and MAC-CE is taken as an example. Optionally, the MAC-CE may correspond to one beam information, or may correspond to multiple beam information.

When the indication signaling corresponds to one beam information, the beam is determined by the beam information.

Optionally, the beam information is configured by RRC signaling; wherein, the RRC signaling includes at least one beam information (in other words, the RRC signaling is a beam information list. In other words, the RRC signaling is a beam information list, and the MAC-CE activates/indicates one of the beam information). Optionally, the beam information list may be understood as tci-StatesToAddModList and/or tci-StatesToReleaseList. Optionally, the beam information list may be understood as dl-OrJoint-TCIStateList or dl-OrJoint-TCI-State-ToAddModList.

Optionally, the tci-StatesToAddModList and/or tci-StatesToReleaseList are in PDSCH-Config. Optionally, the PDSCH-Config is in an active BWP of a cell/serving cell (the cell/serving cell is, for example, the PCell of the NCR-MT; the cell, for example, is indicated by the base station, or the ID of the cell is indicated by the base station; the cell, for example, is the cell that the beam indication signaling (e.g., MAC-CE)) is received.

Optionally, the dl-OrJoint-TCI-State-ToAddModList or dl-OrJoint-TCIStateList is in PDSCH-Config. Optionally, the PDSCH-Config is in an active BWP of a cell/serving cell (the cell/serving cell is, for example, the PCell of the NCR-MT; the cell, for example, is indicated by the base station, or the ID of the cell is indicated by the base station; the cell, for example, is the cell that the beam indication signaling (e.g., MAC-CE)) is received.

Optionally, the NCR determines that the MAC-CE is related to the NCR-Fwd of the NCR according to the logical channel identification (LCID) of the MAC-CE.

Optionally, the beam information refers to at least one of the followings: a TCI state information ID (for example, TCI-StateId, UL-TCIState-Id); a CORESET ID; a reference signal ID (for example, an SSB ID, a CSI-RS ID, an SRS ID/SRI); a spatial relationship ID. Optionally, the beam information is related to the NCR-MT. In other words, the beam information refers to the beam information (configured for the NCR-MT) corresponding to the NCR-MT. For example, the TCI state information ID refers to an index of the (configured) TCI state information corresponding to the NCR-MT.

Optionally, the beam information is a TCI state ID.

Optionally, the beam information is a UL TCI state ID.

Optionally, the beam information is a CORESET ID.

Optionally, the beam information is a reference signal ID.

Optionally, the beam information is a reference signal type.

Optionally, the beam information is a spatial relationship ID.

Optionally, the beam information is an SRI.

Optionally, the beam information is associated with a cell and/or a BWP.

Specific methods performed by the NCR are as follows:

### Method 1

The NCR-MT receives higher-layer indication (configuration) information, and the indication information corresponds to at least one beam information. When the NCR-MT receives the MAC-CE signaling indicating/activating one beam information in at least one beam information, methods performed by the NCR and description of the beam information refer to Example 1 (RRC).

### Method 2

When the NCR-MT receives the MAC-CE signaling indicating/activating one beam information, methods performed by the NCR and description of the beam information refer to Example 1 (RRC).

Additionally, the NCR determines that the MAC-CE is related to the NCR-Fwd of the NCR (for indicating the spatial filter of the NCR-Fwd) according to the LCID of the MAC CE. For example, the NCR learns through the LCID of the MAC-CE that the MAC-CE is the MAC-CE indicating the NCR-Fwd backhaul link beam.

### Example 3 (DCI)

In this example, the indication signaling is DCI. Currently, the DCI is transmitted in a specific form (known as a DCI format). The DCI format includes one or more DCI fields, wherein a DCI field is a TCI field, that is, a transmission configuration indication field, and this field is used to indicate a TCI state.

The beam information is determined by the TCI field and a first field of the DCI, and the beam is determined by the determined beam information.

Optionally, the DCI is with or without downlink allocation. Optionally, in the case that the DCI has downlink allocation, the TCI field and a new DCI field of the DCI can be used to indicate the beam information and then determine the beam. In the case that the DCI has no downlink allocation, the TCI field and existing field of the DCI can be used (reuse of the existing field (such as the first field described below)) to indicate the beam information and then determine the beam.

Optionally, the first field refers to one of the followings: a New Data Indication (NDI) field; a Modulation and Coding Scheme (MCS) field; a Redundancy Version (RV) field and a Frequency Domain Resource Allocation (FDRA) field.

Optionally, the NDI field of the DCI is ‘0’.

Optionally, the RV field of the DCI is all ‘1’.

Optionally, the MCS field of the DCI is all ‘1’.

Optionally, for the case of FDRA type 0, the FDRA field of the DCI is all ‘0’.

Optionally, for the case of FDRA type 1, the FDRA field of the DCI is all ‘1’.

Optionally, for the case of FDRA dynamic switch, the FDRA field of the DCI is all ‘0’.

Specific methods performed by the NCR are as follows:

### Method 1 (New DCI Field)

The NCR-MT receives a DCI, and the DCI includes a TCI field and a new DCI field. Wherein, the new DCI field is used to indicate the TCI state corresponding to the TCI field is for the NCT-MT or the NCR-Fwd. For example, when this field is ‘0 (or 1)’, this DCI is used to indicate the beam information (related TCI state) of the NCR-MT; when this field is ‘1 (or 0)’, this DCI is used to indicate the beam information (related TCI state) of the NCR-Fwd.

### Method 2 (NDI Field)

The NCR-MT receives a DCI, and the DCI includes a TCI field and a NDI field. Wherein, the NDI field is used to indicate that the TCI state corresponding to the TCI field is for the NCT-MT or the NCR-Fwd. For example, when the NDI field is ‘1’, this DCI is used to indicate the beam information (related TCI state) of the NCR-Fwd. Optionally, the DCI has no corresponding DL allocation.

Optionally, the RV field of the DCI is all ‘1’.

Optionally, the MCS field of the DCI is all ‘1’.

Optionally, for the case of FDRA type 0, the FDRA field of the DCI is all ‘0’.

Optionally, for the case of FDRA type 1, the FDRA field of the DCI is all ‘1’.

Optionally, for the case of FDRA dynamic switch, the FDRA field of the DCI is all ‘0’.

### Method 3 (MCS Field)

The NCR-MT receives a DCI, and the DCI includes a TCI field and a MCS field. Wherein, the MCS field is used to indicate that the TCI state corresponding to the TCI field is for the NCT-MT or the NCR-Fwd. For example, when a bit of the MCS field is ‘0’, this DCI is used to indicate the beam information (related TCI state) of the NCR-Fwd. Optionally, the bit of the MCS field is the least significant bit (LSB) or the most significant bit (MSB) of the MCS field.

Optionally, the NDI of the DCI is ‘0’.

Optionally, the RV field of the DCI is all ‘1’.

Optionally, the MCS field of the DCI is ‘1’ except the above bit being ‘0’.

Optionally, for the case of FDRA type 0, the FDRA field of the DCI is all ‘0’;

Optionally, for the case of FDRA type 1, the FDRA field of the DCI is all ‘1’;

Optionally, for the case of FDRA dynamic switch, the FDRA field of the DCI is all ‘0’.

### Method 4 (RV Field)

The NCR-MT receives a DCI, and the DCI includes a TCI field and a RV field. Wherein, the RV field is used to indicate that the TCI state corresponding to the TCI field is for the NCT-MT or the NCR-Fwd. For example, when a bit of the RV field is ‘0’, this DCI is used to indicate the beam information (related TCI state) of the NCR-Fwd. Optionally, the bit of the above RV field is the LSB or MSB of the RV field.

Optionally, the NDI of the DCI is ‘0’.

Optionally, the RV field of the DCI is ‘1’ except the above bit being ‘0’.

Optionally, the MCS of the DCI is all ‘1’.

Optionally, for the case of FDRA type 0, the FDRA field of the DCI is all ‘0’;

Optionally, for the case of FDRA type 1, the FDRA field of the DCI is all ‘1’;

Optionally, for the case of FDRA dynamic switch, the FDRA field of the DCI is all ‘0’.

### Method Five (FDRA Field)

The NCR-MT receives a DCI, and the DCI includes a TCI field and a FDRA field. Wherein, the FDRA field is used to indicate that the TCI state corresponding to the TCI field is for the NCT-MT or the NCR-Fwd. For example, when a bit (e.g., the LSB/MSB) of the FDRA field is ‘0 (or 1)’, this DCI is used to indicate the beam information (related TCI state) of the NCR-Fwd. Optionally, the bit of the above FDRA field is the LSB or MSB of the FDRA field. Optionally, the DCI has no corresponding DL allocation.

For at least one of the methods, optionally, mapping relationship between a TCI field codepoint of the DCI and the TCI state is indicated/mapped by RRC or MAC. Optionally, the RRC signaling refers to the RRC signaling in Example 1. Optionally, the MAC-CE signaling refers to the MAC-CE signaling in Example 2. Optionally, the MAC-CE signaling refers to unified TCI state activation/deactivation MAC CE. Optionally, the MAC-CE signaling refers to TCI states activation/deactivation for UE-specific PDSCH MAC CE. Optionally, the MAC-CE signaling refers to Enhanced TCI states activation/deactivation for UE-specific PDSCH MAC CE.

Optionally, in the methods, the TCI state indicated by the DCI is used for downlink reception and/or uplink forwarding of the NCR-Fwd.

Optionally, in the methods, the DCI refers to DCI format 0_1 and/or DCI format 0_2.

Optionally, in the methods, the DCI refers to DCI format 1_1 and/or DCI format 1_2.

For this example, when the NCR (e.g., NCR-MT) receives the DCI, the NCR (e.g., NCR-Fwd) applies the TCI state indicated by the DCI after the DCI for downlink reception and/or uplink forwarding. Optionally, the TCI state indicated by the DCI is different from the TCI state indicated by the previous DCI. Optionally, after the DCI refers to after a signal (for example, PUCCH or PUSCH) carrying HARQ-ACK information corresponding to the DCI. Optionally, after the DCI refers to after a time period of a signal (for example, PUCCH or PUSCH) carrying HARQ-ACK information corresponding to the DCI. Optionally, after the DCI refers to a first symbol/slot after a time period of a signal (for example, PUCCH or PUSCH) carrying HARQ-ACK information corresponding to the DCI.

Optionally, the time period is configured by the base station, or determined based on an NCR report (for example, a capability report). Optionally, the unit corresponding to the time period is a symbol or a slot.

Optionally, the subcarrier spacing (SCS) corresponding to the slot/symbol (for example, a time period, a first symbol/slot) is determined through an instruction of the base station. Optionally, (if the SCS indicated by the base station is not received), the subcarrier spacing (SCS) corresponding to the slot/symbol (for example, a time period, a first symbol/slot) is determined by one of the methods:

### Method 1

It is determined according to the DCI. For example, the SCS is determined according to the SCS of the BWP that monitors/receives (a PDCCH corresponding to) the DCI.

### Method 2

Reference SCS. Optionally, the reference SCS corresponding to the NCR-Fwd. Optionally, the reference SCS (the reference SCS corresponding to the NCR-Fwd) is configured by the base station. Optionally, the reference SCS refers to a reference subcarrier spacing indication (referenceSubcarrierSpacing) in TDD configuration information (tdd-UL-DL-ConfigurationCommon). Optionally, the TDD configuration information is used for a PCell of the NCR-MT.

### Method 3

SCS of an SSB. Optionally, the SSB is related to the NCR-MT. For example, the subcarrier spacing of the SSB corresponding to the last PRACH transmission of the NCR-MT; for another example, the base station indicates the TCI state of CORESET #0 through MAC-CE signaling, and the SSB corresponds to (associates with) the TCI state.

### Method 4

The SCS is predefined. For example, 15 kHz, 30 kHz, 60 kHz, 120 KHz, 240 KHz.

### Method 5

The SCS is related to a frequency range. Optionally, subcarrier spacings of different frequency ranges may be configured separately (defined separately). Optionally, these frequency ranges include FRI and FR2 (FR2-1 and FR2-2, refer to existing specifications for specific meaning). For example, subcarrier spacing is 15 kHz for FR1; subcarrier spacing is 60 kHz for FR2.

### Method 6

The SCS refers to the subcarrier spacing corresponding to CORESET #0 of the NCR-MT.

### Method 7

The SCS refers to the subcarrier spacing corresponding to the initial BWP of the NCR-MT. For example, subCarrierSpacingCommon in the MIB.

For Embodiment 1, optionally, when the NCR satisfies at least one of the following conditions, the NCR can perform exemplary methods described in Embodiment 1:
The NCR supports beam sweeping (at the gNB side); in other words, the NCR-MT of the NCR supports beam sweeping;
The NCR supports adaptive beam (at the gNB side); in other words, the NCR-MT of the NCR supports adaptive beam;
The NCR supports beam correspondence; in other words, the NCR-MT of the NCR supports beam correspondence;
The NCR-MT of the NCR operates in the same frequency range as the NCR-Fwd (for example, this frequency range is FR2 when the QCL-typeD is applicable);
The NCR-MT and the NCR-Fwd of the NCR operate in a same frequency band;
The NCR-MT of the NCR operates in the passband of the NCR-Fwd of the NCR;
The NCR-MT of the NCR is provided with at least one TCI state; wherein the TCI state includes a QCL-typeD reference signal;
The NCR-MT of the NCR is provided with a unified TCI type;
The NCR-MT of the NCR is in the RRC Connected State;
The NCR (including the NCR-Fwd and the NCR-MT) operates in FR2;
The NCR-MT and the NCR-Fwd of the NCR support independent/separate beam indication of the NCR-MT and the NCR-Fwd;
The NCR (or the NCR-MT) supports simultaneous reception of different QCL-typeD reference signals;
The NCR (or the NCR-MT) does not support simultaneous reception of different QCL-typeD reference signals;
The NCR also receives a second indication signaling indicating at least one of the followings:
Enable independent/separate beam (the TCI state/the QCL-typeD) indication for the NCR-MT and the NCR-Fwd;
Enable independent/separate beam (the TCI state/the QCL-typeD) indication for the NCR control link and the NCR backhaul link.
Enable dedicated/explicit beam indication for backhaul link. Optionally, the indication signaling is carried by RRC signaling.

Advantageous effects of Embodiment 1: Embodiment 1 provides a beam indication method for the NCR-Fwd. The method can explicitly indicate the beam information corresponding to the NCR-Fwd, so that the base station controls the reception beam/transmission beam corresponding to the backhaul link of the NCR-Fwd, thereby improving the link quality of the backhaul link and improving the performance of the communication system.

### Embodiment 2 (NCR-Fwd Implicit Beam Indication)

FIG. 7 illustrates another method 700 performed by an NCR according to embodiments of the disclosure, the NCR includes a mobile terminal and a forward. The method 700 includes, at 701, obtaining beam-related information of the mobile terminal; and at 702, performing, by the forward, downlink reception and/or uplink transmission based on the beam-related information of the mobile terminal.

Specifically, the NCR obtains the beam inFperformation of the NCR-MT of the NCR. The NCR determines the (uplink forwarding/downlink reception) beam of the NCR-Fwd according to the spatial filter corresponding to the above beam information. Here, the beam may be understood as at least one of the followings: a (uplink forwarding/downlink reception) spatial filter; QCL assumption; QCL parameters (QCL-typeD parameters); a TCI state; a Rel-17 TCI state; spatial relationship; information related to an SRS (for example, SRI). In other words, the beam may be understood as a TCI state/reference signal/channel/spatial relationship; or a TCI state ID/reference signal ID/channel ID/spatial relationship ID; or a spatial filter associated with the TCI state/reference signal/channel/spatial relationship; or a spatial filter associated with the TCI state ID/reference signal ID/channel ID/spatial relationship ID. In the following example, the spatial filter associated with the TCI state/reference signal/channel/spatial relationship is taken as an example.

In the disclosure, the beam information may be understood as at least one of the followings: beam information associated with a cell and/or component carrier (CC); beam information associated with a BWP; a TCI state; physical downlink control channel (PDCCH) beam information; physical downlink shared channel (PDSCH) beam information; a reference signal; physical uplink control channel (PUCCH) beam information; physical uplink shared channel (PUSCH) beam information; physical random access channel (PRACH) beam information; beam information obtained from behaviors of the NCR-MT, for example, beam information (e.g., an SSB) determined according to random access procedure of the NCR-MT. Other examples refer to Example 8 described below.

### Example 1 (Rel-17 TCI State)

In this example, the beam information is a TCI state. Optionally, the TCI state is a Rel-17 TCI state. In other words, the NCR-MT is configured with a unified TCI type. In other words, the beam information is at least one of a joint TCI state, a downlink TCI state, and an uplink TCI state.

Specific methods performed by the NCR are as follows:
The NCR obtains the TCI state of the NCR-MT of the NCR. Optionally, the TCI state refers to an indicated TCI state. Optionally, the TCI state refers to a configured TCI state. Optionally, the TCI state refers to an activated TCI state. Optionally, the NCR-MT of the NCR is configured with a unified TCI state type (for example, unifiedtci-StateType). In other words, the TCI state refers to the indicated (unified) TCI state. The NCR performs at least one of the following methods:
Method #1. The NCR determines the spatial filter for downlink reception of the NCR-Fwd of the NCR according to the (downlink reception) spatial filter corresponding to the TCI state. Optionally, the NCR-Fwd uses the spatial filter associated with the TCI state for downlink reception.
Method #2. The NCR determines the spatial filter for uplink forwarding of the NCR-Fwd of the NCR according to the spatial filter corresponding to the TCI state. Optionally, the NCR-Fwd use the spatial filter associated with the TCI state for uplink forwarding.

Optionally, the NCR determines to use Method #1 and/or Method #2 at least according to the indication information of the base station.

Optionally, the NCR determines to use Method #1 and/or Method #2 at least according to the beam correspondence capability of the NCR-MT.

Optionally, the NCR determines to use Method #1 and/or Method #2 at least according to whether the NCR-MT is configured with a unified TCI state type.

Optionally, the cell and/or CC associated with the above beam information (for example, the cell/CC corresponding to the TCI state) is at least one of the followings:
a primary cell (PCell)/a primary secondary cell (PSCell)/SpCell (i.e., PCell+PSCell);
a cell and/or CC with the lowest ID;
a cell and/or CC with the lowest ID in a frequency band. Optionally, this frequency band refers to the frequency band of FR2. Optionally, this frequency band refers to the frequency band where the NCR-Fwd operates;
a cell and/or CC in FR2 (or in other words, the cell configured with a QCL-typeD reference signal);
a cell and/or CC in the same frequency band as the NCR-Fwd;
a secondary cell (SCell);
a cell and/or CC scheduled across carriers;
a CC that is not configured with a CORESET.

Optionally, the BWP associated with the above beam information (the BWP corresponding to the TCI state) is at least one of the followings:
an active BWP;
a BWP with the lowest ID;
an initial BWP;
a DL BWP;
an UL BWP;
all (configured) BWPs of a cell;
a BWP that is not configured with a CORESET.

Optionally, the above TCI state (the indicated TCI state) refers to at least one of the followings:
a unified TCI state.
a joint TCI state. For example, TCI-State.
Optionally, when the TCI state corresponds to the joint TCI state (in other words, when the cell corresponding to the TCI state is configured with the joint TCI state, that is, unifiedTCItci-StateType=‘joint’), the NCR performs Method #1 and Method #2.
a downlink TCI state. For example, TCI-State.
Optionally, when the TCI state corresponds to the DL TCI state (in other words, when the cell corresponding to the TCI state is configured with the DL TCI state and the UL TCI state, that is unifiedTCItci-StateType=‘separate’), the NCR performs the Method #1.
an uplink TCI state. For example, TCI-UL-State.
Optionally, when the TCI state corresponds to the UL TCI state (in other words, when the cell corresponding to the TCI state is configured with the DL TCI state and the UL TCI state, that is, unifiedTCItci-StateType=‘separate’), the NCR performs the Method #2.
a TCI state for a PDCCH/CORESET. For example, the TCI state of CORESET #0.
La TCI state for a PDSCH.
a TCI state for a CSI-RS. Specifically, the CSI-RS refers to a periodic CSI-RS, a semi-persistent CSI-RS, or an aperiodic CSI-RS.
a TCI state for a PDCCH, PDSCH and CSI-RS.
a TCI state for a PUCCH.
a TCI state for a PUSCH.
a TCI state for an SRS. Specifically, the SRS refers to periodic SRS, semi-persistent SRS, or aperiodic SRS.
a TCI state for a PUCCH, PUSCH and SRS.

Optionally, in Example 1, when the NCR (or the NCR-MT) satisfies at least one (or a combination) of the following conditions, or a cell/CC of the NCR (or the NCR-MT) satisfies at least one (or a combination) of the following conditions, the NCR can perform methods described in Example 1 above:
The NCR (the NCR-MT) is provided/configured with a unified TCI state. In other words, the NCR (the NCR-MT) is provided/configured with a unified TCI state type;
The NCR (the NCR-MT) is provided/configured with a UL TCI state (e.g., TCI-UL-State);
The NCR (the NCR-MT) is provided/configured with a TCI state (TCI-State);
The NCR (the NCR-MT) is provided/configured with a joint TCI state;
The NCR (the NCR-MT) is provided/configured with a (joint) TCI state or an UL TCI state;
The NCR (the NCR-MT) is provided/configured with at least one of a (joint) TCI state, a UL TCI state, or a DL TCI state.

Optionally, the above cell/CC refers to at least one or a combination of the followings:
a PCell/PSCell/SpCell;
a SCell;
a cell and/or CC with the lowest ID;
a cell and/or CC with the lowest ID in a frequency band. Optionally, this frequency band refers to the frequency band of FR2. Optionally, this frequency band refers to the frequency band where the NCR-Fwd operates;
a cell and/or CC in the same frequency band as the NCR-Fwd;
a cell and/or CC in FR2 (or in other words, the cell configured with a QCL-typeD reference signal, or the cell configured with at least one TCI state including a QCL-typeD reference signal);
a cell and/or CC scheduled across carriers;
a CC that is not configured with a CORESET.

### Example 2 (PDCCH Beam Information)

In this example, the beam information is PDCCH beam information. In other words, the beam information is at least one of a PDCCH/CORESET TCI state, a PDCCH/CORESET QCL assumption, a QCL-typeD reference signal corresponding to the PDCCH/CORESET QCL assumption, and PDCCH/CORESET QCL parameters.

Specific methods performed by the NCR are as follows:
The NCR obtains the PDCCH beam information of the NCR-MT of the NCR. The NCR performs at least one of the following methods:
Method #1. The NCR determines the spatial filter for downlink reception of the NCR-Fwd of the NCR according to the (downlink reception) spatial filter corresponding to the PDCCH beam information. Optionally, the NCR-Fwd uses PDCCH beam information (associated spatial filter) for downlink reception.
Method #2. The NCR determines the spatial filter (or spatial relationship) for uplink forwarding of the NCR-Fwd of the NCR according to the spatial filter (or spatial relationship) corresponding to the PDCCH beam information. Optionally, the NCR-Fwd uses the PDCCH beam information (associated/corresponding spatial filter/spatial relationship) for uplink forwarding.

Optionally, the PDCCH beam information refers to at least one (or a combination) of the followings:
a (configured/activated/indicated/applied) TCI state of the CORESET;
a (configured/activated/indicated/applied) QCL assumption of the CORESET;
a QCL assumption/indication of the CORESET;
a QCL-typeD reference signal corresponding to the TCI state of the CORESET;
a QCL-typeD reference signal corresponding to the QCL assumption/indication of the CORESET.

Optionally, the above cell/CC corresponding to the CORESET is at least one of the followings:
a PCell/PSCell/SpCell;
a SCell;
a cell and/or CC with the lowest ID;
a cell and/or CC with the lowest ID in a frequency band. Optionally, this frequency band refers to the frequency band of FR2. Optionally, this frequency band refers to the frequency band where the NCR-Fwd operates;
a cell and/or CC in the same frequency band as the NCR-Fwd;
a cell and/or CC in FR2 (or in other words, the cell configured with a QCL-typeD reference signal, or the cell configured with at least one TCI state including a QCL-typeD reference signal).

Optionally, the above BWP corresponding to the CORESET is at least one of the followings:
an active BWP;
a BWP with the lowest ID;
an initial BWP;
a DL BWP, for example, in a case that the TCI state is a DL TCI state or a joint TCI state;
all (configured) BWPs of a cell.

Optionally, the above ID (the ID corresponding to the CORESET) is:
the lowest ID, which refers to the CORESET with the lowest ID.
0, i.e, referring to CORESET #0.

Optionally, the above CORESET includes (or does not include) at least one of the following search spaces:
an USS;
a CSS;
a Type 3 CSS.

Optionally, the above CORESET refers to the CORESET with the lowest ID among the active BWPs of one cell/CC. Optionally, the cell/CC refers to at least one of the followings:
a PCell;
a SCell;
a cell and/or CC with the lowest ID;
a cell and/or CC in the same frequency band as the NCR-Fwd;
a cell and/or CC in FR2 (or in other words, the cell configured with a QCL-typeD reference signal, or the cell configured with at least one TCI state including a QCL-typeD reference signal);

Optionally, the above (configured/activated/indicated/applied) QCL assumption of the CORESET refers to: the QCL assumption of the CORESET in the latest slot. For example, the PDCCH QCL indication of the CORESET (associated with the monitored search space) with the lowest CORESET ID in the latest slot (where the NCR-MT monitors one or more CORESETs within the active BWP of one serving cell/CC). Optionally, the serving cell/CC is at least one of the followings:
a PCell;
a SCell;
a cell and/or CC with the lowest ID;
a cell and/or CC in the same frequency band as the NCR-Fwd;
a cell and/or CC in FR2 (or in other words, the cell configured with a QCL-typeD reference signal, or the cell configured with at least one TCI state including a QCL-typeD reference signal).

Optionally, the above (configured/activated/indicated/applied) TCI state of the CORESET refers to:
One of the configured TCI states corresponding to the CORESET (the first or the one with the lowest TCI state ID). For example, RRC (tci-StatesPDCCH-ToAddList and/or tci-StatesPDCCH-ToReleaseList) configures one or more TCI states for the CORESET, the TCI state is the first of one or more TCI states.
The first of the activated TCI states/codepoints corresponding to the CORESET. For example, the MAC-CE activates one or more TCI states/codepoints for the CORESET, and the TCI state/codepoint is the first of the one or more TCI states/codepoints.

Optionally, the Method #2 is enabled by RRC signaling. The reason is that one condition for implementing Method #2 is that the NCR-MT supports beam correspondence (has beam correspondence capability). At this time, the function of this RRC signaling is to enable the NCR with beam correspondence capability to use Method #2.

### Example 3 (PDSCH Beam Information)

In this example, the beam information is PDSCH beam information. In other words, the beam information is at least one of a PDSCH TCI state, a PDSCH QCL assumption, and a PDSCH QCL parameter.

Specific methods performed by the NCR are as follows:

The NCR obtains the PDSCH beam information of the NCR-MT of the NCR. NCR performs at least one of the following methods:
Method #1. The NCR determines the spatial filter for downlink reception of the NCR-Fwd of the NCR according to the (downlink reception) spatial filter corresponding to the PDSCH beam information. Optionally, the NCR-Fwd uses spatial filter associated with the PDSCH beam information for downlink reception.
Method #2. The NCR determines the spatial filter for uplink forwarding of the NCR-Fwd of the NCR according to the (downlink reception) spatial filter corresponding to the PDSCH beam information. Optionally, the NCR-Fwd uses spatial filter associated with the PDSCH beam information for uplink forwarding.

Optionally, the above cell/CC corresponding to the PDSCH beam information is at least one of the followings:
a PCell/PSCell/SpCell;
a SCell;
a cell and/or CC with the lowest ID;
a cell and/or CC in the same frequency band as the NCR-Fwd;
a cell and/or CC with the lowest ID in a frequency band. Optionally, this frequency band refers to the frequency band of FR2. Optionally, this frequency band refers to the frequency band where the NCR-Fwd operates;
a cell and/or CC in FR2 (or in other words, the cell configured with a QCL-typeD reference signal);
a cell and/or CC scheduled across carriers;
a cell and/or CC that is not configured with a CORESET.

Optionally, the above BWP corresponding to the PDSCH beam information is at least one of the followings:
an active BWP;
a BWP with the lowest ID;
an initial BWP;
a DL BWP, for example, in a case that the TCI state is a DL TCI state or a joint TCI state;
all (configured) BWPs of a cell;
a BWP that is not configured with a CORESET.

Optionally, the above PDSCH beam information refers to at least one of the followings:
a (configured/activated/indicated/applied) TCI state of the PDSCH;
a (configured/activated/indicated/applied) QCL assumption of the PDSCH.

Optionally, the above (configured/activated/indicated/applied) TCI state of the PDSCH refers to:
One of the configured TCI states of the PDSCH (the first, or the one with the lowest TCI state ID). For example, RRC (tci-StatesPDCCH-ToAddList and/or tci-StatesPDCCH-ToReleaseList) configures one or more TCI states for the PDSCH, the TCI state is the first or the one with the lowest TCI state ID among the one or more TCI states.
One of the activated TCI states of the PDSCH. For example, MAC-CE activates one or more TCI states (PDSCH TCI states), the TCI state is the first or the one with the lowest TCI state ID among the one or more TCI states.
One or more TCI states corresponding to one of the TCI codepoints (the lowest codepoint). Optionally, the association between TCI state and TCI codepoint is indicated by the MAC-CE.

Optionally, the Method #2 is enabled by RRC signaling. The reason is that one condition for implementing Method #2 is that the NCR-MT supports beam correspondence. At this time, the function of this RRC signaling is to enable the NCR with beam correspondence capability to use Method #2.

### Example 4 (Reference Signal)

In this example, the beam information is a reference signal (for example, the reference signal is at least one of an SSB, a CSI-RS, and an SRS, which refers to the resource of the reference signal and corresponds to the panel information/capability [group] index). In other words, the reference signal is at least one of the corresponding TCI state (or the TCI state QCLed with the reference signal, or a QCL-typeD reference signal of the TCI state), and the spatial filter associated/corresponding to the reference signal. The following takes the spatial filter corresponding to the reference signal as an example.

Specific methods performed by the NCR are as follows:

The NCR obtains the spatial filter of the reference signal of the NCR-MT of the NCR. The NCR performs at least one of the following methods:
Method #1. The NCR determines the spatial filter for downlink reception of the NCR-Fwd of the NCR according to the (downlink reception) spatial filter corresponding to the reference signal. Optionally, the NCR-Fwd uses spatial filter associated with the reference signal for downlink reception.
Method #2. The NCR determines the spatial filter for uplink forwarding of the NCR-Fwd of the NCR according to the (downlink reception) spatial filter corresponding to the reference signal. Optionally, the NCR-Fwd uses spatial filter associated with the reference signal for uplink forwarding.

Optionally, the above cell/CC corresponding to the reference signal is at least one of the followings:
a PCell/PSCell/SpCell;
a SCell;
a cell and/or CC with the lowest ID;
a cell and/or CC in the same frequency band as the NCR-Fwd;
a cell and/or CC with the lowest ID in a frequency band. Optionally, this frequency band refers to the frequency band of FR2. Optionally, this frequency band refers to the frequency band where the NCR-Fwd operates;
a cell and/or CC in FR2 (or in other words, the cell configured with a QCL-typeD reference signal);
a cell and/or CC scheduled across carriers;
a cell and/or CC that is not configured with a CORESET.

Optionally, the above BWP corresponding to the reference signal is at least one of the followings:
an active BWP;
a BWP with the lowest ID;
an initial BWP;
a DL BWP;
all (configured) BWPs of a cell;
a BWP that is not configured with a CORESET;
a CC that is not configured with a CORESET.

Optionally, the above reference signal refers to at least one of the followings:
reference signal identified by the NCR-MT during initial access procedure.
Optionally, before the NCR-MT is provided with a TCI state (e.g., TCI-State), the NCR-Fwd uses/applies the spatial filter corresponding to this reference signal.
Optionally, before the NCR-MT is provided with a unified TCI state (e.g., TCI-State), the NCR-Fwd uses/applies the spatial filter corresponding to this reference signal.
Optionally, before the NCR-MT is provided with a joint TCI state (e.g., TCI-State), the NCR-Fwd uses/applies the spatial filter corresponding to this reference signal.
Optionally, before (any) one CORESET of the active BWP of the NCR-MT is provided with a TCI state (e.g., TCI-State), the NCR-Fwd uses/applies the spatial filter corresponding to this reference signal.
The reference signal identified by the NCR-MT in random access procedure initiated by the Reconfiguration with sync procedure.
Optionally, when the high-level configuration information received by the NCR-MT includes multiple TCI states (the high-level configuration information is part of a reconfiguration with sync procedure), and before applying one of these states, the NCR-Fwd uses/applies the spatial filter corresponding to this reference signal.
The reference signal identified by the NCR-MT during the beam failure recovery procedure (or in other words, the link recovery procedure). In other words, the reference signal (q_{new}) identified by the NCR-MT in the candidate beam reference signal list.
Optionally, after the NCR-MT receives the beam failure response (for example, after 28 symbols), the NCR-Fwd uses/applies the spatial filter corresponding to the reference signal (Method #1 and/or Method #2).
Optionally, the beam failure response refers to the PDCCH. Optionally, the PDCCH is scrambled by the C-RNTI. Optionally, the search space corresponding to the PDCCH is used for beam failure recovery random access response (BFR RAR). Optionally, the PDCCH refers to the PDCCH for determining the completion of contention-based random access procedure.

In this example, optionally, if the reference signal is an SRS (SRS resource), the SRS (SRS resource) refers to at least one of the followings:
The SRI with the lowest ID (or lowest codepoint). For example, SRI with value 0 (SRI=0), SRI with codepoint 0 (all 0);
Optionally, the SRS resource group corresponding to the NCR-MT includes multiple SRS resource. Wherein, the SRI is suitable for indicating the SRS resource in the resource group.
SRS resource;
Optionally, the SRS resource group corresponding to the NCR-MT configures one (single) SRS resource.
the SRS associated with the SRS resource set with the lowest ID;
the SRS with the lowest SRS resource ID.

Optionally, the Method #1/Method #2 is enabled by RRC signaling. The reason is that one condition for implementing Method #1/Method #2 is that the NCR-MT supports beam correspondence. At this time, the function of this RRC signaling is to enable the NCR with beam correspondence capability to use Method #1/Method #2. For example, when the reference signal is a downlink reference signal, the Method #2 is enabled by the RRC signaling. When the reference signal is an uplink reference signal, the Method #1 is enabled by the RRC signaling.

### Example 5 (PUCCH Beam Information)

In this example, the beam information is PUCCH beam information. Optionally, the PUCCH beam information is at least one of the spatial relationship corresponding to the PUCCH resource, and the spatial filter the associated with/corresponding to the PUCCH (resource).

Specific methods performed by the NCR are as follows:

The NCR obtains the PUCCH beam information of the NCR-MT of the NCR. The NCR performs at least one of the following methods:
Method #1. The NCR determines the spatial filter for uplink forwarding of the NCR-Fwd of the NCR according to the spatial filter/spatial relationship corresponding to the PUCCH beam information. Optionally, the NCR-Fwd uses the PUCCH beam information (associated spatial filter) for uplink forwarding.
Method #2. The NCR determines the spatial filter for downlink reception of the NCR-Fwd of the NCR according to the spatial filter/spatial relationship corresponding to the PUCCH beam information. Optionally, the NCR-Fwd uses the PUCCH beam information (associated spatial filter) for downlink reception.

Optionally, the above PUCCH beam information refers to at least one (or a combination) of the followings:
The spatial relationship corresponding to a PUCCH resource;
The spatial filter associated with/corresponding to a PUCCH (resource).

Optionally, the above cell/CC corresponding to the PUCCH resource refers to at least one of the followings:
a PCell;
a SCell;
a cell and/or CC with the lowest ID;
a cell and/or CC in the same frequency band as the NCR-Fwd;
a cell and/or CC with the lowest ID in a frequency band. Optionally, this frequency band refers to the frequency band of FR2. Optionally, this frequency band refers to the frequency band where the NCR-Fwd operates;
a cell and/or CC in FR2 (or in other words, the cell configured with a QCL-typeD reference signal);
a cell and/or CC scheduled across carriers;
a CC that is not configured with a CORESET.

Optionally, the above BWP corresponding to the above PUCCH resource is at least one of the followings:
an active BWP;
a BWP with the lowest ID;
an initial BWP;
an UL BWP;
all (configured) BWPs of a cell.
a BWP that is not configured with a CORESET.

Optionally, the above PUCCH resource refer to dedicated PUCCH resource.

Optionally, the above PUCCH resource refers to the PUCCH resource with the lowest ID.

Optionally, the above PUCCH refers to the latest/last PUCCH transmission.

Optionally, the above PUCCH resource refers to a dedicated PUCCH resource with the lowest ID in the active uplink BWP of one cell/CC. Optionally, the cell/CC refers to at least one of the followings:
a PCell;
a SCell;
a cell and/or CC with the lowest ID;
a cell and/or CC in the same frequency band as the NCR-Fwd;
a cell and/or CC in FR2 (or in other words, the cell configured with a QCL-typeD reference signal);
a cell and/or CC scheduled across carriers;
a CC that is not configured with a CORESET.

Optionally, the Method #2 is enabled by RRC signaling. The reason is that one condition for implementing Method #2 is that the NCR-MT supports beam correspondence. At this time, the function of this RRC signaling is to enable the NCR with beam correspondence capability to use Method #2.

Optionally, Method #2 of Example 2 and Method #1 of Example 5 can be combined. For example, when the NCR-MT supports beam correspondence (or in other words, transmits signaling supporting the capability of the beam correspondence), NCR-Fwd uses Method #2 in Example 2 for uplink forwarding; when the NCR-MT does not support beam correspondence (or in other words, transmits signaling that does not support the capability of the beam correspondence), the NCR-Fwd uses Method #1 in Example 5 for uplink forwarding. More specifically, when the NCR-MT has indicated that the capability beamCorrespondenceWithoutUL-BeamSweeping is set to ‘1’, the NCR-Fwd determines/uses/references/according to the reference signal configured with qcl-Type set to ‘typeD’ corresponding to the QCL assumption of the CORESET with the lowest ID on the activated DL BWP of PCell for uplink link forwarding; otherwise (NCR-MT has indicated that the capability beamCorrespondenceWithoutUL-BeamSweeping is set to ‘0’), NCR-Fwd determines/uses/refers/according to the spatial relationship corresponding to the dedicated PUCCH resource with the lowest ID (within the activated UL BWP of PCell) for uplink forwarding.

### Example 6 (PUSCH Beam Information)

In this example, the beam information is PUSCH beam information. Optionally, the PUSCH beam information is at least one of the spatial relationship corresponding to the PUSCH, the SRI associated with/corresponding to the PUSCH, and the spatial filter associated with/corresponding to the PUSCH.

Specific methods performed by the NCR are as follows:
The NCR obtains the PUSCH beam information of the NCR-MT of the NCR. The NCR performs at least one of the following methods:
Method #1. The NCR determines the spatial filter for uplink forwarding of the NCR-Fwd of the NCR according to the spatial filter/spatial relationship corresponding to the PUSCH beam information. Optionally, the NCR-Fwd uses the PUSCH beam information (associated spatial filter) for uplink forwarding.
Method #2. The NCR determines the spatial filter for downlink reception of the NCR-Fwd of the NCR according to the spatial filter/spatial relationship corresponding to the PUSCH beam information. Optionally, the NCR-Fwd uses the PUSCH beam information (associated spatial filter) for downlink reception.

Optionally, the PUSCH beam information refers to at least one (or a combination) of the followings:
The spatial relationship corresponding to the PUSCH;
The SRI associated with/corresponding to the PUSCH;
The spatial filter associated with/corresponding to the PUSCH.

Optionally, the above cell/CC corresponding to the PUSCH refers to at least one of the followings:
a PCell;
a SCell;
a cell and/or CC with the lowest ID;
a cell and/or CC in the same frequency band as the NCR-Fwd;
a cell and/or CC with the lowest ID in a frequency band. Optionally, this frequency band refers to the frequency band of FR2. Optionally, this frequency band refers to the frequency band where the NCR-Fwd operates;
a cell and/or CC in FR2 (or in other words, the cell configured with a QCL-typeD reference signal).

Optionally, the above BWP corresponding to the PUSCH resource is at least one of the followings:
an active BWP;
a BWP with the lowest ID;
an initial BWP;
an UL BWP;
all (configured) BWPs of a cell.

Optionally, the above PUSCH refers to at least one of the followings:
the PUSCH scheduled by DCI format 0_0;
the latest/last PUSCH transmission;
the PUSCH scheduled by the RAR UL grant in the initial access procedure;
the PUSCH scheduled by the RAR UL grant in random access procedure initiated by the Reconfiguration with sync procedure.

Optionally, the Method #2 is enabled by RRC signaling. The reason is that one condition for implementing Method #2 is that the NCR-MT supports beam correspondence. At this time, the function of this RRC signaling is to enable the NCR with beam correspondence capability to use Method #2.

Optionally, Method #2 of Example 2 and Method #1 of Example 6 can be combined. For example, the NCR determines to use Method #2 of Example 2 or Method #1 of Example 6 according to the capability of the terminal (NCR). Specifically, when the NCR-MT supports beam correspondence (or in other words, transmits signaling supporting the capability of the beam correspondence), NCR-Fwd uses Method #2 in Example 2 for uplink forwarding; when the NCR-MT does not support beam correspondence (or in other words, transmits signaling that does not support the capability of the beam correspondence), the NCR-Fwd uses Method #1 in Example 6 for uplink forwarding. More specifically, when the NCR-MT has indicated that the capability beamCorrespondenceWithoutUL-BeamSweeping is set to ‘0’, the NCR-Fwd determines/uses/references/according to the reference signal configured with qcl-Type set to ‘typeD’ corresponding to the QCL assumption of the CORESET with the lowest ID on the activated DL BWP of PCell for uplink link forwarding; otherwise (NCR-MT has indicated that the capability beamCorrespondenceWithoutUL-BeamSweeping is set to ‘0’), NCR-Fwd determines/uses/refers/according to the spatial relation corresponding to PUSCH scheduled by DCI format 0_0 (within the activated UL BWP in PCell for uplink forwarding. Optionally, the PUSCH refers to the last PUSCH transmission.

### Example 7 (PRACH Beam Information)

In this example, the beam information is PRACH beam information. Optionally, the PRACH beam information is the spatial filter associated with/corresponding to the PRACH (transmission). Optionally, the PRACH beam information is a reference signal associated with/corresponding to the PRACH (transmission) (for example, SSB or CSI-RS).

Specific methods performed by the NCR are as follows:
The NCR obtains the PRACH beam information of the NCR-MT of the NCR. The NCR performs at least one of the following methods:
Method #1. The NCR determines the spatial filter for uplink forwarding of the NCR-Fwd of the NCR according to the spatial filter/spatial relationship corresponding to the PRACH beam information. Optionally, the NCR-Fwd uses the PRACH beam information (associated spatial filter) for uplink forwarding.
Method #2. The NCR determines the spatial filter for downlink reception of the NCR-Fwd of the NCR according to the spatial filter/spatial relationship corresponding to the PRACH beam information. Optionally, the NCR-Fwd uses the PRACH beam information (associated spatial filter) for downlink reception.

Optionally, the above cell/CC corresponding to the PRACH (transmission) refers to at least one of the followings:
a PCell;
a SCell;
a cell and/or CC with the lowest ID;
a cell and/or CC in the same frequency band as the NCR-Fwd;
a cell and/or CC with the lowest ID in a frequency band. Optionally, this frequency band refers to the frequency band of FR2. Optionally, this frequency band refers to the frequency band where the NCR-Fwd operates;
a cell and/or CC in FR2 (or in other words, the cell configured with a QCL-typeD reference signal).

Optionally, the above PRACH (transmission) refers to at least one of the followings:
Last PRACH transmission.
Optionally, after the NCR-MT receives the beam failure response (for example, after 28 symbols), the NCR-Fwd uses/applies the spatial filter corresponding to the PRACH (Method #1 and/or Method #2).
Optionally, the beam failure response refers to the PDCCH. Optionally, the PDCCH is scrambled by the C-RNTI. Optionally, the search space corresponding to the PDCCH is used for BFR RAR. Optionally, the PDCCH refers to the PDCCH for determining the completion of contention-based random access procedure.

Optionally, the Method #2 is enabled by RRC signaling. The reason is that one condition for implementing Method #2 is that the NCR-MT supports beam correspondence. At this time, the function of this RRC signaling is to enable the NCR with beam correspondence capability to use Method #2.

### Example 8 (Beam Information Obtained by Behaviors of the NCR-MT)

In Example 8, the beam information is the beam information of the NCR-MT obtained by the NCR through behaviors of the NCR-MT. Optionally, behaviors of the NCR-MT refers to at least one of the followings:
random access procedure. For example, the initial access procedure, random access procedure initiated by the Reconfiguration with sync procedure;
link recovery procedure;
beam failure recovery procedure;
radio link failure recovery procedure.

The NCR determines the beam of the NCR-Fwd of the NCR according to the obtained beam information. NCR performs at least one of the following methods:
Method #1. The NCR determines the spatial filter for uplink forwarding of the NCR-Fwd of the NCR according to the spatial filter/spatial relationship corresponding to the beam information. Optionally, the NCR-Fwd uses the beam information (associated spatial filter) for uplink forwarding.
Method #2. The NCR determines the spatial filter for downlink reception of the NCR-Fwd of the NCR according to the spatial filter/spatial relationship corresponding to the beam information. Optionally, the NCR-Fwd uses the beam information (associated spatial filter) for downlink reception.

It should also be noted that, optionally, in the above examples (Example 2-Example 8), when the NCR (or NCR-MT) satisfies at least one (or a combination) of the following conditions, or one cell/CC of the NCR (or NCR-MT) satisfies at least one (or a combination) of the following conditions, the NCR can perform methods described in the above Example 2-Example 8:
The NCR (the NCR-MT) is not provided/configured with a unified TCI state. Optionally, the NCR (the NCR-MT) is not provided/configured with a unified TCI state type;
The NCR (the NCR-MT) is not provided/configured with a UL TCI state (e.g., TCI-UL-State);
The NCR (the NCR-MT) is not provided/configured with a joint TCI state;
The NCR (the NCR-MT) is not provided/configured with a (joint) TCI state or UL TCI state;
The NCR (the NCR-MT) is not provided/configured with at least one of a (joint) TCI state, a UL TCI state, and a DL TCI state.

Optionally, the above cell/CC refers to at least one or a combination of the followings:
a PCell/PSCell/SpCell;
a SCell;
a cell and/or CC with the lowest ID;
a cell and/or CC in the same frequency band as the NCR-Fwd;
a cell and/or CC in FR2 (or in other words, the cell configured with a QCL-typeD reference signal, or the cell configured with at least one TCI state including a QCL-typeD reference signal).

For this Embodiment 2, optionally, when the NCR satisfies at least one of the following conditions, the NCR can perform the methods in the examples described in the above Embodiment 2:
The NCR supports beam sweeping (at the gNB side); in other words, the NCR-MT of the NCR supports beam sweeping;
The NCR supports adaptive beam (at the gNB side); in other words, the NCR-MT of the NCR supports adaptive beam;
The NCR supports beam correspondence; in other words, the NCR-MT of the NCR supports beam correspondence;
The NCR-MT of the NCR operates in the same frequency range as the NCR-Fwd (this frequency range is FR2 if the QCL-typeD is applicable);
The NCR-MT and the NCR-Fwd of the NCR operate in a same frequency band;
The NCR-MT of the NCR operates in the passband of the NCR-Fwd of the NCR;
The NCR-MT of the NCR is provided with at least one TCI state; wherein the TCI state includes a QCL-typeD reference signal;
The NCR-MT of the NCR is provided with a unified TCI type;
The NCR-MT of the NCR is in the RRC Connected State;
The NCR (including the NCR-Fwd and the NCR-MT) operates on FR2;
The NCR-MT and the NCR-Fwd of the NCR support independent/separate beam indication of the NCR-MT and the NCR-Fwd;
The NCR (or the NCR-MT) supports simultaneous reception of different QCL-typeD reference signals;
The NCR (or the NCR-MT) does not support simultaneous reception of different QCL-typeD reference signals;
The NCR does not support dedicated/explicit beam indication for backhaul link;
The NCR does not receive signaling for indicating beam indication for backhaul link. For example, the NCR does not receive the beam indication (or beam indication information/signaling) described in Embodiment 1.
The NCR also receives a second indication signaling indicating at least one of the followings:
Enable independent/separate beam (the TCI state/the QCL-typeD) indication for the NCR-MT and the NCR-Fwd;
Enable independent/separate beam (the TCI state/the QCL-typeD) indication for the NCR control link and the NCR backhaul link.
The NCR also receives a second indication signaling, and the NCR does not receive the beam indication (or beam indication information/signaling) described in Embodiment 1. Optionally, the second indication signaling indicates at least one of the followings:
Enable dedicated/explicit beam indication for backhaul link. Optionally, the indication signaling is carried by RRC signaling.

Advantageous effects of Embodiment 2: Embodiment 2 provides a beam indication method for the NCR-Fwd. The method can enable the NCR determine the beam information corresponding to the NCR-Fwd implicitly through the beam information corresponding to the NCR-MT, so as to properly adjust the reception beam/transmission beam corresponding to the backhaul link of the NCR-Fwd, thereby improving the link quality of the backhaul link and improving the performance of the communication system.

### Embodiment 3

The NCR (for example, NCR-MT) receives first indication information and second indication information; wherein,
the first indication information indicates first beam information (for example, a beam index) and a corresponding first time resource;
the second indication information indicates second beam information (for example, a beam index) and a corresponding second time resource;
if the first time resource and the second time resource overlap, the NCR (for example, NCR-Fwd) does not apply/do not use the second indication information or the first indication information; or the NCR (for example, NCR-Fwd) applies/uses the first indication information or the second indication information; or the NCR (for example, NCR-Fwd) applies/uses the first indication information or the second indication information in the overlapping part of the first time resource and the second time resource; or the NCR (for example, NCR-Fwd) does not apply/do not use the first indication information or the second indication information in the overlapping part of the first time resource and the second time resource.

Optionally, the first indication information is dynamic indication information.

Optionally, the first indication information is carried by DCI.

Optionally, the second indication information is semi-static indication information.

Optionally, the second indication information is carried by MAC-CE and/or RRC.

Optionally, the first indication information indicating the first beam information and the corresponding first time resource means that the first indication information indicates that the NCR-Fwd applies/uses the first beam information in the first time resource (for forwarding, or for uplink/downlink forwarding).

Optionally, the second indication information indicating the second beam information and the corresponding second time resource means that the second indication information indicates that the NCR-Fwd applies/uses the second beam information in the second time resource (for forwarding, or for uplink/downlink forwarding).

Optionally, the NCR does not apply/do not use the second indication information or the first indication information means that the NCR does not apply/does not use the second beam information in the second time resource (for forwarding, or for uplink/downlink forwarding); or the NCR does not apply/does not use the first beam information in the first time resource (for forwarding, or for uplink/downlink forwarding).

Optionally, the NCR applies/uses the first indication information or the second indication information means that the NCR applies/uses the first beam information in the first time resource (for forwarding, or for uplink/downlink forwarding); or the NCR applies/uses the second beam information in the second time resource (for forwarding, or for uplink/downlink forwarding).

Optionally, the NCR applies/uses the first indication information or the second indication information in the overlapping part of the first time resource and the second time resource means that the NCR applies/uses the first beam information or the second beam information in the overlapping part of the first time resource and the second time resource (for forwarding, or for uplink/downlink forwarding).

Optionally, the NCR does not apply/do not use the first indication information or the second indication information in the overlapping part of the first time resource and the second time resource means that the NCR does not apply/do not use the first beam information and the second beam information in the overlapping part of the first time resource and the second time resource (for forwarding, or for uplink/downlink forwarding).

Optionally, the first beam information is different from the second beam information. Optionally, the first beam information being different from the second beam information means that the index corresponding to the first beam information is different from the index corresponding to the second beam information. For example, the first beam information is beam #1 (that is, the beam index is 1); the second beam information is beam #2 (that is, the beam index is 2). At this time, the first beam information is different from the second beam information. It can be understood that the NCR will perform the above behaviors when the first beam information is different from the second beam information.

Advantageous effects of Embodiment 3: Embodiment 3 provides a beam indication method for the NCR-Fwd. This method can enable NCR to correctly process/use/determine the corresponding beam under the condition of obtaining multiple indications related to the beam, thereby improving the link quality of the backhaul link and improving the performance of the communication system.

### Embodiment 4

The NCR (for example, NCR-MT) receives first indication information and second indication information; wherein,
the first indication information indicates first beam information (for example, a beam index) and a corresponding first time resource;
the second indication information indicates second beam information (for example, a beam index) and a corresponding second time resource;
if the signal carrying the first indication information is earlier than the second time resource and the first time resource and the second time resource overlap, the NCR (for example, NCR-Fwd) does not apply the first indication information; or the NCR (for example, NCR-Fwd) applies the first indication information or the second indication information; or the NCR (for example, NCR-Fwd) applies the first indication information or the second indication information in the overlapping part of the first time resource and the second time resource; or the NCR (for example, NCR-Fwd) does not apply the first indication information or the second indication information in the overlapping part of the first time resource and the second time resource.

Optionally, the first indication information is dynamic indication information.

Optionally, the first indication information is carried by DCI.

Optionally, the second indication information is semi-static indication information.

Optionally, the second indication information is carried by MAC-CE and/or RRC.

Optionally, the first indication information indicating the first beam information and the corresponding first time resource means that the first indication information indicates that the NCR-Fwd applies/uses the first beam information in the first time resource (for forwarding, or for uplink/downlink forwarding).

Optionally, the second indication information indicating the second beam information and the corresponding second time resource means that the second indication information indicates that the NCR-Fwd applies/uses the second beam information in the second time resource (for forwarding, or for uplink/downlink forwarding).

Optionally, the NCR does not apply/do not use the second indication information or the first indication information means that the NCR does not apply/does not use the second beam information in the second time resource (for forwarding, or for uplink/downlink forwarding); or the NCR does not apply/does not use the first beam information in the first time resource (for forwarding, or for uplink/downlink forwarding).

Optionally, the NCR applies/uses the first indication information or the second indication information means that the NCR applies/uses the first beam information in the first time resource (for forwarding, or for uplink/downlink forwarding); or the NCR applies/uses the second beam information in the second time resource (for forwarding, or for uplink/downlink forwarding).

Optionally, the NCR applies/uses the first indication information or the second indication information in the overlapping part of the first time resource and the second time resource means that the NCR applies/uses the first beam information or the second beam information in the overlapping part of the first time resource and the second time resource (for forwarding, or for uplink/downlink forwarding).

Optionally, the NCR does not apply/do not use the first indication information or the second indication information in the overlapping part of the first time resource and the second time resource means that the NCR does not apply/do not use the first beam information and the second beam information in the overlapping part of the first time resource and the second time resource (for forwarding, or for uplink/downlink forwarding).

Optionally, the first beam information is different from the second beam information. Optionally, the first beam information being different from the second beam information means that the index corresponding to the first beam information is different from the index corresponding to the second beam information. For example, the first beam information is beam #1 (that is, the beam index is 1); the second beam information is beam #2 (that is, the beam index is 2). At this time, the first beam information is different from the second beam information. It can be understood that the NCR will perform the above behaviors when the first beam information is different from the second beam information.

Optionally, the signal carrying the first indication information is earlier than the second time resource means that the signal carrying the first indication information (for example, the last time unit of the signal; for example, the last time unit of the CORESET corresponding to the signal) is earlier than the second time resource (e.g., the first time unit of the second time resource).

Optionally, the signal carrying the first indication information is earlier than the second time resource means that the signal carrying the first indication information (for example, the last time unit of the signal; for example, the last time unit of CORESET corresponding to the signal) and the second time resource (e.g., the first time unit of the second time resource) have a time domain offset greater than or equal to a specific threshold. Optionally, the threshold is indicated by the base station. Optionally, the threshold is predefined. Optionally, the threshold is related to the capability of the NCR (or related to the capability reporting of the NCR). For example, the threshold is BeamAppTime or timeDurationForQCL. Optionally, the threshold is related to a first time domain length and a second time domain length (for example, the sum of the first time domain length and the second time domain length); wherein, the first time domain length is determined according to BeamapTime or timeDurationForQCL (in other words, the first time domain length is equal to that corresponding length of BeamapTime or timeDurationForQCL); the second time domain length is related to the capability of the NCR (or related to the capability reporting of the NCR).

Optionally, the time unit may be one of a frame, a subframe, a slot, a sub-slot, and a symbol.

Advantageous effects of Embodiment 4: Embodiment 4 provides a beam determination method for the NCR-Fwd. This method can enable NCR to correctly process/use/determine the corresponding beam under the condition of obtaining multiple indications related to the beam, thereby improving the link quality of the backhaul link and improving the performance of the communication system. In addition, this method considers the sequential relationship between the indication information and the indicated time resource, so that NCR has enough time to process the corresponding indication information, thereby improving the reliability of the system.

### Embodiment 5

The NCR (for example, NCR-MT) receives first indication information; wherein,
the first indication information indicates first beam information (for example, a beam index) and a corresponding first time resource;
the NCR (for example, NCR-Fwd) determines/expects that the signal carrying the first indication information is earlier than the first time resource.

Optionally, the first indication information is dynamic indication information.

Optionally, the first indication information is carried by DCI.

Optionally, the first indication information indicating the first beam information and the corresponding first time resource means that the first indication information indicates that the NCR-Fwd applies/uses the first beam information in the first time resource (for forwarding, or for uplink/downlink forwarding).

Optionally, the NCR applies/uses the first indication information means that the NCR applies/uses the first beam information in the first time resource (for forwarding, or for uplink/downlink forwarding).

Optionally, the signal carrying the first indication information is earlier than the first time resource means that the signal carrying the first indication information (for example, the last time unit of the signal; for example, the last time unit of the CORESET corresponding to the signal) is earlier than the first time resource (e.g., the first time unit of the first time resource).

Optionally, the signal carrying the first indication information is earlier than the first time resource means that the signal carrying the first indication information (for example, the last time unit of the signal; for example, the last time unit of CORESET corresponding to the signal) and the first time resource (e.g., the first time unit of the first time resource) have a time domain offset greater than or equal to a specific threshold. Optionally, the threshold is indicated by the base station. Optionally, the threshold is predefined. Optionally, the threshold is related to the capability of the NCR (or related to the capability reporting of the NCR). For example, the threshold is BeamAppTime or timeDurationForQCL. Optionally, the threshold is related to a first time domain length and a second time domain length (for example, the sum of the first time domain length and the second time domain length); wherein, the first time domain length is determined according to BeamapTime or timeDurationForQCL (in other words, the first time domain length is equal to that corresponding length of BeamapTime or timeDurationForQCL); the second time domain length is related to the capability of the NCR (or related to the capability reporting of the NCR).

Optionally, the time unit may be one of a frame, a subframe, a slot, a sub-slot, and a symbol.

Advantageous effects of Embodiment 5: Embodiment 5 provides a beam determination method for the NCR-Fwd. This method considers the sequential relationship between the indication information and the indicated time resource, so that NCR has enough time to process the corresponding indication information, thereby improving the reliability of the system.

### Embodiment 6

The NCR (for example, NCR-MT) receives first indication information; wherein,
the first indication information indicates first beam information (for example, a beam index) and a corresponding first time resource;
if the signal carrying the first indication information is earlier than the first time resource, the NCR (for example, NCR-Fwd) applies the first indication information.

Optionally, the first indication information is dynamic indication information.

Optionally, the first indication information is carried by DCI.

Optionally, the first indication information indicating the first beam information and the corresponding first time resource means that the first indication information indicates that the NCR-Fwd applies/uses the first beam information in the first time resource (for forwarding, or for uplink/downlink forwarding).

Optionally, the NCR applies/uses the first indication information means that the NCR applies/uses the first beam information in the first time resource (for forwarding, or for uplink/downlink forwarding).

Optionally, the signal carrying the first indication information is earlier than the first time resource means that the signal carrying the first indication information (for example, the last time unit of the signal; for example, the last time unit of the CORESET corresponding to the signal) is earlier than the first time resource (e.g., the first time unit of the first time resource).

Optionally, the signal carrying the first indication information is earlier than the first time resource means that the signal carrying the first indication information (for example, the last time unit of the signal; for example, the last time unit of CORESET corresponding to the signal) and the first time resource (e.g., the first time unit of the first time resource) have a time domain offset greater than or equal to a specific threshold. Optionally, the threshold is indicated by the base station. Optionally, the threshold is predefined. Optionally, the threshold is related to the capability of the NCR (or related to the capability reporting of the NCR). For example, the threshold is BeamAppTime or timeDurationForQCL. Optionally, the threshold is related to a first time domain length and a second time domain length (for example, the sum of the first time domain length and the second time domain length); wherein, the first time domain length is determined according to BeamapTime or timeDurationForQCL (in other words, the first time domain length is equal to that corresponding length of BeamapTime or timeDurationForQCL); the second time domain length is related to the capability of the NCR (or related to the capability reporting of the NCR).

Optionally, the time unit may be one of a frame, a subframe, a slot, a sub-slot, and a symbol.

Advantageous effects of Embodiment 6: Embodiment 56 provides a beam determination method for the NCR-Fwd. This method considers the sequential relationship between the indication information and the indicated time resource, so that NCR has enough time to process the corresponding indication information, thereby improving the reliability of the system.

FIG. 8 illustrates a method 800 performed by a base station according to various embodiments of the disclosure. The method 800 includes, at 801, determining signaling including beam-related information; and at 802, transmitting the signaling to a repeater.

The mobile terminal NCR-MT and the NCR-Fwd of the repeater (NCR) shown in FIG. 5 are respectively configured to perform the corresponding methods disclosed wherein above.

FIG. 9 illustrates a structure 900 of a base station according to various embodiments of the disclosure. As shown in FIG. 9, the base station 900 includes a controller 910 and a transceiver 920, wherein the controller 910 is configured to perform the method as described above in FIG. 8, and the transceiver 920 is configured to transmit and receive data or signals.

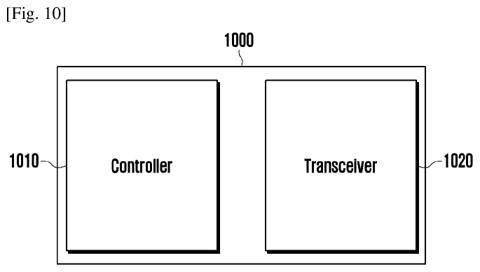

FIG. 10 illustrates another structure 1000 of a network-controlled repeater according to various embodiments of the disclosure. As shown in FIG. 10, the network-controlled repeater 1000 includes a controller 1010 and a transceiver 1020, wherein the controller 1010 is configured to perform the corresponding method disclosed wherein, and the transceiver 1020 is configured to transmit and receive data or signals.

It can also be understood that “at least one/at least one” described in the disclosure includes any and/or all possible combinations of listed items, various embodiments described in the disclosure and various examples in embodiments can be changed and combined in any suitable form, and “/” described in the disclosure means “and/or”.

Furthermore, it can be understood that the beam ID may be understood as a logical beam ID. For example, the network-controlled repeater described in the disclosure can also be understood as a reconfigurable intelligent surface (RIS), and the corresponding method can also be applied to the intelligent hypersurface.

The illustrative logical blocks, modules, and circuits described in the disclosure may be implemented in a general-purpose processor, a Digital Signal Processor (DSP), an application specific integrated circuit, ASIC), Field Programmable Gate Array (FPGA) or other programmable logic devices, discrete gate or transistor logic, discrete hardware components, or any combination thereof designed to perform the functions described wherein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in the disclosure may be embodied directly in hardware, in a software module performed by a processor, or in a combination of the both. Software modules may reside in RAM memory, flash memory, ROM memory, EPROM memory, EEPROM memory, registers, hard disks, removable disks, or any other form of storage media known in the art. An exemplary storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more exemplary designs, the described functions may be implemented in hardware, software, firmware, or any combination thereof. If implemented in software, each function can be stored on or transmitted by a computer-readable medium as one or more instructions or codes. Computer-readable media include both computer storage media and communication media, and the latter includes any media that facilitates the transfer of computer programs from one place to another. The storage medium can be any available medium that can be accessed by a general-purpose or special-purpose computer.

The description set forth wherein, taken in conjunction with the drawings, describes example configurations, methods and devices, and does not represent all examples that can be realized or are within the scope of the claims. As used wherein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on any invention or the scope of the claimed protection, but as descriptions of specific features of specific embodiments of specific inventions. Some features described in this specification in the context of separate embodiments can also be combined in a single embodiment. On the contrary, various features described in the context of a single embodiment can also be implemented separately in multiple embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the present invention is illustrative of an exemplary process. Based on the design preference, it can be understood that the specific order or hierarchy of steps in the method can be rearranged to realize the functions and effects disclosed in the present invention. The appended method claims present elements of various steps in an example order, and are not meant to be limited to the particular order or hierarchy presented, unless otherwise specifically stated. Furthermore, although elements may be described or claimed in the singular, the plural is also contemplated unless the limitation on the singular is explicitly stated. Therefore, the disclosure is not limited to the illustrated examples, and any means for performing the functions described wherein are included in various aspects of the disclosure.

Text and drawings are provided as examples only to help readers understand the disclosure. They are not intended and should not be construed to limit the scope of the disclosure in any way. Although certain embodiments and examples have been provided, based on the disclosure wherein, it is obvious to those skilled in the art that changes can be made to the illustrated embodiments and examples without departing from the scope of the disclosure.

1-15. (canceled)

16. A method performed by a network controlled repeater (NCR) in a wireless communication system, the method comprising:
receiving, from a base station, at least one physical downlink control channel (PDCCH) in a control resource set (CORESET);
identifying whether the NCR receives at least one of an indication of a transmission configuration indication (TCI) state or an indication of a unified TCI state; and
in case that the NCR does not receive the indication of the TCI state and the indication of the unified TCI state, performing receptions on a backhaul link using same quasi-colocation (QCL) parameters as used for receiving the at least one PDCCH in the CORESET,
wherein the CORESET includes a lowest identifier (ID) in an active downlink (DL) bandwidth part (BWP).

17. The method of claim 16, further comprising in case that the NCR does not receive the indication of the TCI state and the NCR receives the indication of the unified TCI state, performing the receptions on the backhaul link using QCL parameters provided by the unified TCI state.

18. The method of claim 17, wherein the NCR includes at least one of an NCR-mobile terminal (MT) or an NCR-forward (Fwd), and
wherein the indication of the unified TCI state is for receptions by the NCR-MT.

19. The method of claim 16, further comprising in case that the NCR receives the indication of the TCI state, performing the receptions on the backhaul link using QCL parameters provided by the TCI state in a medium access control (MAC) control element (CE),
wherein the MAC CE includes an ID of the TCI state in the active DL BWP.

20. A method performed by a base station in a wireless communication system, the method comprising:
transmitting, to a network controlled repeater (NCR), at least one physical downlink control channel (PDCCH) in a control resource set (CORESET); and
performing a transmission on a backhaul link when the base station does not transmit an indication of a transmission configuration indication (TCI) state and an indication of a unified TCI state;
wherein the NCR uses same quasi-colocation (QCL) parameters for receiving the at least one PDCCH in the CORESET and for receiving the transmission on the backhaul link, and
wherein the CORESET includes a lowest identifier (ID) in an active downlink (DL) bandwidth part (BWP).

21. The method of claim 20, further comprising performing the transmission on the backhaul link when the base station does not transmit the indication of the TCI state and the base station transmits the indication of the unified TCI state,
wherein QCL parameters provided by the unified TCI state are used by the NCR for receiving the transmission on the backhaul link when the base station does not transmit the indication of the TCI state and the base station transmits the indication of the unified TCI state.

22. The method of claim 21, wherein the NCR includes at least one of an NCR-mobile terminal (MT) or an NCR-forward (Fwd), and
wherein the indication of the unified TCI state is for receptions by the NCR-MT.

23. The method of claim 20, further comprising performing the transmission on the backhaul link when the base station transmits the indication of the TCI state,
wherein QCL parameters provided by the TCI state in a medium access control (MAC) control element (CE) are used by the NCR receiving the transmission on the backhaul link when the base station transmits the indication of the TCI state,
wherein the MAC CE includes an ID of the TCI state in the active DL BWP.

24. A network controlled repeater (NCR) in a wireless communication system, the NCR comprising:
a transceiver; and
at least one processor coupled with the transceiver and configured to:
receive, from a base station, at least one physical downlink control channel (PDCCH) in a control resource set (CORESET),
identify whether the NCR receives at least one of an indication of a transmission configuration indication (TCI) state or an indication of a unified TCI state, and
in case that the NOR does not receive the indication of the TCI state and the indication of the unified TCI state, perform receptions on a backhaul link using same quasi-colocation (QCL) parameters as used for receiving the at least one PDCCH in the CORESET,
wherein the CORESET includes a lowest identifier (ID) in an active downlink (DL) bandwidth part (BWP).

25. The NCR of claim 24, wherein the at least one processor is further configured to, in case that the NCR does not receive the indication of the TCI state and the NCR receives the indication of the unified TCI state, perform the receptions on the backhaul link using QCL parameters provided by the unified TCI state.

26. The NCR of claim 25, wherein the NCR includes at least one of an NCR-mobile terminal (MT) or an NCR-forward (Fwd), and
wherein the indication of the unified TCI state is for receptions by the NCR-MT.

27. The NCR of claim 24, wherein the at least one processor is further configured to, in case that the NCR receives the indication of the TCI state, perform the receptions on the backhaul link using QCL parameters provided by the TCI state in a medium access control (MAC) control element (CE), and
wherein the MAC CE includes an ID of the TCI state in the active DL BWP.

28. A base station in a wireless communication system, the base station comprising:
a transceiver; and
at least one processor coupled with the transceiver and configured to:
transmit, to a network controlled repeater (NCR), at least one physical downlink control channel (PDCCH) in a control resource set (CORESET), and
perform a transmission on a backhaul link when the base station does not transmit an indication of a transmission configuration indication (TCI) state and an indication of a unified TCI state,
wherein the NCR uses same quasi-colocation (QCL) parameters for receiving the at least one PDCCH transmission in the CORESET and for receiving the transmission on the backhaul link, and
wherein the CORESET includes a lowest identifier (ID) in an active downlink (DL) bandwidth part (BWP).

29. The base station of claim 28, wherein the at least one processor is further configured to perform the transmission on the backhaul link when the base station does not transmit the indication of the TCI state and the base station transmits the indication of the unified TCI state, and
wherein QCL parameters provided by the unified TCI state are used by the NCR for receiving the transmission on the backhaul link when the base station does not transmit the indication of the TCI state and the base station transmits the indication of the unified TCI state.

30. The base station of claim 29, wherein the NCR includes at least one of an NCR-mobile terminal (MT) or an NCR-forward (Fwd), and
wherein the indication of the unified TCI state is for receptions by the NCR-MT.

31. The base station of claim 28, wherein the at least one processor is further configured to perform the transmission on the backhaul link when the base station transmits the indication of the TCI state,
wherein QCL parameters provided by the TCI state in a medium access control (MAC) control element (CE) are used by the NCR for receiving the transmission on the backhaul link when the base station transmits the indication of the TCI state,
wherein the MAC CE includes an ID of the TCI state in the active DL BWP.
